(19) United States
(12) Patent Application Publication
(10) Pub. No.: US 2024/0299899 A1
(43) Pub. Date: Sep. 12, 2024

(54) PYROLYSIS REACTOR WITH INTEGRATED HEAT EXCHANGE

(71) Applicant: CZERO, INC., Goleta, CA (US)

(72) Inventors: Samuel SHANER, Goleta, CA (US); Brett PARKINSON, Goleta, CA (US); Andrew CALDWELL, Goleta, CA (US); Ryan PATRICK, Goleta, CA (US)

(21) Appl. No.: 18/272,029

(22) PCT Filed: Jan. 11, 2022
(86) PCT No.: PCT/US2022/012001

§ 371 Date: Jul. 12, 2023

Related U.S. Application Data
(60) Provisional application No. 63/136,316, filed on Jan. 12, 2021.

(51) Int. Cl. B01J 19/00

(52) U.S. Cl. CPC B01J 19/0013; B01J 19/0053; B01J 2219/00121; B01J 2219/3325

(57) ABSTRACT

A direct contact heat exchanger for a molten media reactor can include a plurality of trays or stages disposed in a vessel, a molten media flow path configured to pass a molten media through the plurality of trays or stages, and a gas pathway disposed through the plurality of trays or stages. The gas pathway is configured to directly contact a gas phase fluid with the molten media on the plurality of trays or stages.

### CROSS-REFERENCE TO RELATED APPLICATIONS

This application claims priority to U.S. Provisional Patent Application No. 63/136,316 filed on Jan. 12, 2021, and entitled “Pyrolysis Reactor with Integrated Heat Exchange,” which is incorporated herein in its entirety by reference.

### STATEMENT REGARDING FEDERALLY SPONSORED RESEARCH OR DEVELOPMENT

This invention was made with Government support under Grant #DE-AR0001194 awarded by the Department of Energy. The Government has certain rights in this invention.

### SUMMARY

In some embodiments, a direct contact heat exchanger for a molten media reactor comprises a plurality of trays or stages disposed in a vessel, a molten media flow path configured to pass a molten media through the plurality of trays or stages, and a gas pathway disposed through the plurality of trays or stages. The gas pathway is configured to directly contact a gas phase fluid with the molten media on the plurality of trays or stages.

In some embodiments, a method of exchanging heat in a molten media reactor comprises passing a molten media through a plurality of trays or stages in a reactor vessel, passing a gas phase fluid through a gas pathway through the plurality of trays or stages, and contacting the molten media with a gas phase fluid within the reactor vessel. The gas phase fluid directly contacts the molten media on the plurality of trays or stages.

In some embodiments, a molten media reactor comprises a reactor vessel, a first direct contact heat exchanger disposed in an upper portion of the reactor vessel, a second direct contact heat exchanger disposed in a lower portion of the reactor vessel, and a reaction zone located between the first direct contact heat exchanger and the second direct contact heat exchanger.

In some embodiments, a method comprises passing a molten media into an upper portion of a reactor vessel, passing a feed gas into a lower portion of the reactor vessel, pyrolyzing the feed gas in a central portion of the reactor vessel to form reaction products, heating the molten media in the upper portion of the reactor vessel using direct contact heat exchange between the molten media and the reaction products, cooling the molten media in the lower portion of the reactor vessel using direct contact heat exchange between the molten media and the feed gas, and passing the molten media out of the reactor vessel after cooling the molten media in the lower portion of the reactor vessel.

These and other features will be more clearly understood from the following detailed description taken in conjunction with the accompanying drawings and claims.

### BACKGROUND

The transformation of chemical feedstocks into products relies on reactors with controlled internal conditions. Conversion of hydrocarbon feedstocks such as natural gas containing methane with strong carbon-hydrogen bonds is particularly challenging and typically utilizes reactors containing catalysts and/or making use of high temperatures. A major limitation in chemical reaction engineering is the inability to perform very high temperature reactions efficiently at high pressure due to the limitations of reactor designs. For reversible reactions, equilibrium limitations, can also make very high temperatures desirable but limited by reactor material considerations. This is especially true in corrosive environments. Above approximately 1000° C. few moderate cost materials can be used for construction of safe pressure vessels.

One example of an important reaction that would be favorable at very high temperatures is natural gas pyrolysis. In pyrolysis of hydrocarbon reactants the molecules are dehydrogenated, cracked and broken down into lighter hydrocarbons, olefins, aromatics, and/or solid carbon. It is generally cost effective to operate at high pressures and equilibrium restrictions favor the use of very high temperatures. A catalyst may be used as well to hasten reaction rates and improve selectivities. Methane pyrolysis by rapid heating in a reaction zone has been investigated.

### BRIEF DESCRIPTION OF THE DRAWINGS

For a more complete understanding of the present disclosure, reference is now made to the following brief description, taken in connection with the accompanying drawings and detailed description:

FIG. 1 is a schematic illustration of an embodiment of a molten media reactor.

FIG. 2 is a schematic illustration of a direct contact heat exchanger for use with an embodiment of a molten media reactor.

FIG. 3 is a schematic illustration of another direct contact heat exchanger for use with an embodiment of a molten media reactor.

FIG. 4 is a schematic illustration of still another direct contact heat exchanger for use with an embodiment of a molten media reactor.

FIG. 5 is a schematic illustration of yet another direct contact heat exchanger for use with an embodiment of a molten media reactor.

FIG. 6 is a schematic illustration of another direct contact heat exchanger for use with an embodiment of a molten media reactor.

FIG. 7 is a schematic illustration of still another direct contact heat exchanger for use with an embodiment of a molten media reactor.

FIGS. 8A and 8B are schematic illustrations of an embodiments of molten media reactors.

FIG. 9 is a schematic illustration of a heater for use with an embodiment of a molten media reactor.

FIG. 10 is a schematic illustration of another heater for use with an embodiment of a molten media reactor.

FIG. 11 is a schematic illustration of still another heater for use with an embodiment of a molten media reactor.

FIG. 12 is a schematic illustration of yet another heater for use with an embodiment of a molten media reactor.

FIGS. 13A and 13B are schematic illustrations of recycle line for use with an embodiment of a molten media reactor.

FIGS. 14A and 14B illustrate heat transfer and reaction models for a molten media reactor.

FIG. 15A illustrates still another heat transfer and reaction model for a molten media reactor.

FIG. 15B illustrates a temperature profile based on the heat transfer models.

FIG. 16 illustrates multiple temperature profiles based on the heat transfer models.

FIG. 17 illustrates the results of a sensitivity analysis for the molten media reactor models.

### DESCRIPTION

This disclosure relates to the manufacture of chemicals and solid carbon from natural gas making use of a molten media in a reactor to remove the carbon from the reactor. More specifically, this disclosure relates to molten media reactor designs with integrated heat exchange.

At present, industrial hydrogen is produced primarily using the steam methane reforming (SMR) process, and the product effluent from the reactors contains not only the desired hydrogen product but also other gaseous species including gaseous carbon oxides (CO/CO₂) and unconverted methane. Separation of the hydrogen for shipment or storage and separation of the methane for recirculation back to the reformer is carried out in a pressure swing adsorption (PSA) unit, a costly and energy-intensive separation. Generally the carbon oxides are released to the environment. This separation process exists as an independent unit after reaction. Overall the process produces significant carbon dioxide. Natural gas is also widely used to produce power by combustion with oxygen in air, again producing significant amounts of carbon dioxide.

Methane pyrolysis can be used as a means of producing hydrogen and solid carbon. The reaction, CH₄↔2H₂+C is limited by equilibrium such that at pressures of approximately 5-40 bar which are need for industrial production and temperatures below 1,000° C. the methane conversion is relatively low.

The systems and methods described herein are based on transformation of natural gas or other molecules or mixtures of molecules containing predominately hydrogen and carbon atoms into a solid carbon product that can be readily handled and prevented from forming carbon dioxide in the atmosphere, as well as a gas phase co-product comprising hydrogen. The overall process in this case can be referred to as pyrolysis, CₙH₂ₘ→mH₂+nC.

The present systems and methods according to many embodiments shows how to significantly improve on previous attempts to transform gases containing carbon and hydrogen into chemicals including hydrogen and solid carbon through the use of an environment containing a molten media, whereby the solid carbon can be removed from the reactor carried by the gas phase and/or the molten media in a much lower cost and practically easier way than known before.

As disclosed herein, a reactor can comprise integrated heat exchange to improve the reactor operation. Molten media reactors can operate at temperatures between about 1000° C. and about 1300° C. In order to retain heat within the reactor, the feed gas can be preheated in a heat exchanger. Hydrocarbon feed gases may start to pyrolyze around 600° C., making pre-heating beyond this limit difficult in traditional indirect heat exchanger designs. For example, the heat exchanger surfaces may start to form coke and plug the reactor flow pathways. In order to limit this type of fouling, the pre-heating can be limited to less than the pyrolysis temperature. Introducing a feed gas to the reactor section at this temperature can result in cooling of the molten media, making it difficult to maintain a proper reaction temperature and increasing the heat burden of high temperature reactor heating.

Disclosed herein are reactor configurations using direct contact heat exchange useful for exchanging heat between the feed and the molten media to pre-heat the feed prior to the feed reaching the reaction zone. The heat exchange concept can also be used to exchange heat between the products leaving the reaction zone and the molten media passing into the reaction zone. This can maintain the heat from the reaction zone within the reactor. Complicating the heat exchange between the products and the incoming molten media is the presence of solid carbon in the product stream. The solid carbon can be present as solid particles entrained in the gas stream and/or within the molten media. These particles can agglomerate on the heat exchange surfaces and potentially block or clog any gas flow. The configurations disclosed herein can take this type of potential fouling into consideration and allow effective heat exchange without carbon buildup within the reactor.

Also disclosed herein are heating methods for the molten media within the reaction zone. The heat can be applied externally to the reactor vessel and/or within the reactor vessel. The heat configurations can also allow for co-current molten media/reactant flow in some aspects. This can help to drive liquid flow through the heat exchanger.

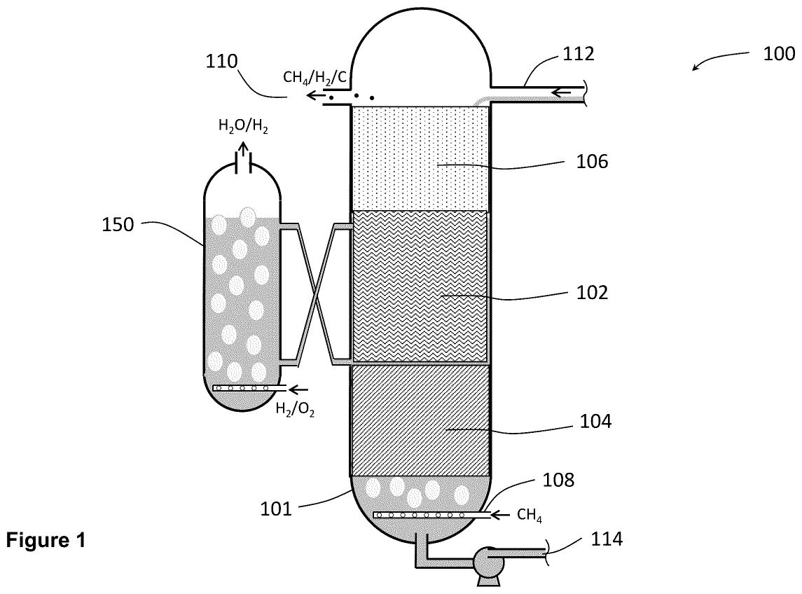

A conceptual flow diagram of the pyrolysis reactor is shown schematically in FIG. 1. As shown, a reactor vessel 101 can comprise a number of zones or areas within the reactor vessel 101. A central reaction zone 102 can be present at or near the center of the reactor vessel 101 (e.g., within a central ½ of the reactor vessel 101 in a vertical direction). A lower feed pre-heat zone 104 can be located below the reaction zone 102, and an upper product exchange zone 106 can be located above the reaction zone 102. Within the reactor, a feed comprising a reactant gas can enter through the inlet 108. A sparger or other distributor can be used to provide the feed gas into the reactor vessel 101, which may be in the form of bubbles or a gas stream in contact with the molten media. The feed gas can pass through the feed pre-heat zone 104 in a counter current flow to the molten media, which can pass out of the reactor vessel 101 through a molten media outlet 114. Within the feed pre-heat zone 104, the feed can exchange heat with the molten media leaving the reaction zone 102 to pre-heat the feed gases. In some aspects, the feed may be pre-heated outside of the reactor vessel 101 and may enter the reactor vessel 101 at a temperature between about 200° C. and about 600° C. Within feed pre-heat zone 104, the feed gas can be heated to a reaction temperature before entering the reaction zone 102.

Within the reaction zone 102, the feed gas can contact the molten media to convert at least a portion of the reactants, which can comprise hydrocarbons, into solid carbon and a gas phase product. In some aspects, the gas phase product can comprise hydrogen. The products and any unreacted feed gas (e.g., the gaseous products) can then pass upwards into the product exchange zone 106, where the gaseous products can undergo heat exchange through direct contact with an incoming recycled stream of molten media. The gaseous products can be cooled from the reaction temperature to less than about 800° C. before leaving the reactor vessel 101 through outlet 110 based on heat exchange with the molten media entering through molten media inlet 112. Conversely the molten media can be heated based on exchange with the gaseous products prior to entering the reaction zone 102.

In order to maintain the molten media temperature within the reaction zone, a variety of heat exchanger options are available. As shown in FIG. 1, an external heat exchanger 150 can be used to receive a portion of the molten media from the product exchange zone 106 and/or an upper portion of the reaction zone 102, heat the molten media, and return the molten media to a lower portion of the reaction zone 102 and/or an upper portion of the feed pre-heat zone 104. This configuration can allow the feed gas and molten media to have a co-current flow within the reaction zone 102, while the gas phase and molten media phases in the feed pre-heat zone 104 and the product exchange zone 106 can have a counter-current flow.

The reactant gas can comprise any gas containing a hydrocarbon such as methane, ethane, propane, etc. and/or mixture such as natural gas. In some embodiments, a common source for methane is natural gas which may also contain associated hydrocarbons ethane and other alkanes and impurity gases which may be supplied into the reactor vessel 101. The natural gas also may be sweetened and/or dehydrated prior to being used in the system. Other sources of hydrocarbon(s) can include biogas, renewable natural gas, methane from biological sources (e.g., digesters, etc.), and the like. The methods and apparatus disclosed herein can convert the hydrocarbons such as methane to carbon and hydrogen, and may also serve to simultaneously convert some fraction of the associated higher hydrocarbons to carbon and hydrogen.

While natural gas is described in some aspects herein, the feed can also comprise other hydrocarbon gases. For example, higher molecular weight hydrocarbons including aromatic and/or aliphatic compounds, including alkenes and alkynes, can also be present depending on the source of the hydrocarbon feed. Exemplary additional components can include, but are not limited to, ethane, ethylene, acetylene, propane, butane, butadiene, benzene, etc. When other components are present with methane, the components can be present in a volume percentage ranging from 0.1 vol. % to about 20 vol. %, or from about 0.5 vol. % to about 5 vol. %. In addition to other hydrocarbons, other components having elements other than hydrogen and carbon can also be present. For example, elements such as small amounts of nitrogen, oxygen, sulfur, phosphorous, and other components can be present in minor amounts, and the use of the term hydrocarbon with respect to the feed does not necessarily require pure hydrocarbons to the exclusion of other heteroatoms.

As described herein, the pyrolysis reactor can comprise a molten media. The molten media can comprise one or more molten metals and/or one or more molten salts. In some aspects, the molten media may comprise one or more solids within the molten media to aid in the reaction.

In some aspects, the molten media can comprise a molten metal, a combination of molten metals, and/or alloys or emulsions of molten metals. A composition of molten materials for performing hydrocarbon pyrolysis can include a metal having a high solubility for carbon including but not limited to alloys of Ni, Fe, Mn, and/or Al. A composition of molten materials for performing hydrocarbon pyrolysis can include a metal which has limited solubility to carbon including but not limited to alloys of Cu, Sn, Ag, Ga, Bi, Au, Pb.

In some embodiments, the molten media may comprise a low-melting point metal with relatively low activity for the desired reaction combined with a metal with higher intrinsic activity for the desired reaction, but with a melting point above the desired operating temperature of reaction to form an alloy. The alloy may also comprise one or more additional metals, which may further improve the activity, lower the melting point, and/or otherwise improve the performance of the catalytic alloy or catalytic process. It is understood and within the scope of the present disclosure that the melting point of a catalytic alloy may be at or above the reaction temperature, and the liquid operates as a supersaturated melt or with one or more components precipitating. It is also understood and within the scope of the present disclosure that one or more reactants, products, or intermediates dissolves or is otherwise incorporated into the melt and therefore generates a catalytic alloy which is not purely metallic. Such an alloy is still referred to as a molten metal, molten media, or liquid phase metal herein.

In some embodiments, the molten media comprising a molten metal can comprise nickel, bismuth, copper, platinum, indium, lead, gallium, iron, palladium, tin, cobalt, tellurium, ruthenium, antimony, gallium, aluminum, oxides thereof, or any combination thereof. For example, combinations of metals having activity for hydrocarbon pyrolysis may include, but are not limited to: nickel-bismuth, copper-bismuth, platinum-bismuth, nickel-indium, copper-indium, copper-lead, nickel-gallium, copper-gallium, iron-gallium, palladium-gallium, platinum-tin, cobalt-tin, bismuth-tin, nickel-tellurium, and/or copper-tellurium.

In some embodiments, the components of the molten metal can comprise between 5 mol. % and 95 mol. %, or between 10 mol. % and 90 mol. %, or between 15 mol. % and 85 mol. % of a first component, with the balance being at least one additional metal. In some embodiments, at least one metal may be selected to provide a desired phase characteristic within the selected temperature range. For example, at least one component can be selected with a suitable percentage to ensure the mixture is in a liquid state at the reaction temperature. Further, the amount of each metal can be configured to provide the phase characteristics as desired such as homogeneous molten metal mixture, an emulsion, or the like.

In some embodiments, the molten media can be or can comprise a molten salt. The molten salt(s) can comprise any salts that have high solubilities for carbon and/or solid carbon particles in the molten phase, or have properties that facilitate solid carbon suspension making them suitable media for the reactive-separation of hydrocarbon dehydrogenation processes. The transport of solid carbon or carbon atoms in molten salts away from the gas phase reactions within bubbles can be effective in increasing the reactant conversion, as most thermal hydrocarbon processes have solid carbon formation. The affinity of solid carbon in molten salts is specific to the salt and can vary greatly.

The selection of the salt can also vary depending on the salt density. The selection of the molten salt(s) can affect the density of the resulting molten salt mixture. The density can be selected to allow solid carbon to be separated by either being less dense or denser than the solid carbon, thereby allowing the solid carbon to be separated at the bottom or top of the reactor, respectively. In some embodiments as described herein, the carbon formed in the reactor can be used to form a slurry with the molten salt. In these embodiments, the salt(s) can be selected to allow the solid carbon to be neutrally buoyant or nearly neutrally buoyant in the molten salt(s).

The salts can be any salt having a suitable melting point to allow the molten salt or molten salt mixture to be formed within the reactor. In some embodiments, the salt mixture comprises one or more oxidized atoms (M)+m and corresponding reduced atoms (X)-1, wherein M is at least one of K, Na, Mg, Ca, Mn, Zn, La, or Li, and wherein X is at least one of F, Cl, Br, I, OH, SO₃, or NO₃. Exemplary salts can include, but not limited to, NaCl, NaBr, KCl, KBr, LiCl, AlCl₃, LiBr, CaCl₂), MgCl₂, CaBr₂, MgBr₂, and combinations thereof.

When combinations of two or more salts are used, the individual compositions can be selected based on the density, interaction with other components, solubility of carbon, ability to remove or carry carbon, and the like. In some embodiments, a eutectic mixture can be used in the molten salt mixture. For example, a eutectic mixture of KCl (44 wt. %) and MgCl₂ (56 wt %) can be used as the salt mixture in the molten salt. Other eutectic mixtures of other salts are also suitable for use with the systems and methods disclosed herein.

The selection of the salt in the molten salt mixture can affect the resulting structure of the carbon. For example, the carbon morphology can be controlled through the selection of the reaction conditions and molten salt composition. The produced carbon can comprise carbon black, graphene, graphite, carbon nanotubes, carbon fibers, or the like. For example, the use of some mixtures of salts (e.g., MnCl₂/KCl) can produce a highly crystalline carbon, whereas the use of a single salt may produce carbon having a lower crystallinity.

In some embodiments, the salt itself can be designed to have catalytic activity without added catalysts (e.g., solid or molten metals, etc.). In other embodiments, salts without alkali metals such as, but not limited, to MnCl₂, ZnCl₂, AlCl₃, when used with host salts including mixtures of KCl, NaCl, KBr, NaBr, CaCl₂), MgCl₂ can provide a reactive environment that dehydrogenates the alkane producing carbon within the melt. In some embodiments, fluorine-based salts (e.g., fluorides) can be used in the pyrolysis of any of the feed gas components described herein, such as natural gas. In some embodiments, magnesium-based salts such as MgCl₂, MgBr₂, and/or MgF₂ can be used for hydrocarbon pyrolysis including methane pyrolysis. Magnesium-based salts may allow for high conversion with relatively simple separation of the salt and carbon.

In some embodiments, the molten media can comprise a solid phase, which can be catalytic towards the hydrocarbon pyrolysis reaction. Within any of the molten media compositions described herein (e.g., molten metal(s)/molten salt(s), etc.), a portion of the molten media may be molten, and one or more additional components or elements may be present as solids to produce a multiphase composition. For example, one component may be a liquid phase metal and/or salt and a second component may be in the solid phase, with the two components forming a slurry or the solid may be fixed to a structure (or form the structure) around which the molten media flows. The solid may be itself a salt, a metal, a non-metal, or a combination of multiple solid components that include a salt, a metal, or a non-metal.

In some embodiments, a multiphase composition within a molten media can comprise one or more molten salts, molten metals, metal alloys, and molten metal mixtures that have high solubilities for hydrogen and low solubilities for hydrocarbons, making them suitable media for the reactive-separation of hydrocarbon dehydrogenation processes, such as hydrocarbon pyrolysis. The molten media may form an emulsion or dispersion within another molten salt or metal phase and/or another solid component may be on a solid support (e.g. Al₂O₃). The transport of solid carbon or carbon atoms in molten metals could play a similar role as hydrogen in the effective increase in reactant conversion, as most thermal hydrocarbon processes have solid carbon formation. The solubility of solid carbon in molten metals is specific to the metal and can vary greatly.

In some embodiments, solid components such as solid metals, metal oxides, metal carbides, and in some embodiments, solid carbon, can also be present within a molten salt as catalytic components. For example, solid components can be present within the molten solution and can include, but are not limited to a solid comprising a metal (e.g. Ni, Fe, Co, Cu, Pt, Ru, etc.), a metal carbide (e.g. MoC, WC, SiC, etc.), a metal oxide (e.g. MgO, CaO, Al₂O₃, CeO₂, etc.), a metal halide (e.g., MgF₂, CaF₂, etc.), solid carbon, and any combination thereof. The solid component can be present as particles present as a slurry or as a fixed component within the reactor. The particles can have a range of sizes, and in some embodiments, the particles can be present as nano and/or micro scale particles. Suitable particles can include elements of magnesium, iron, aluminum, nickel, cobalt, copper, platinum, ruthenium, cerium, combinations thereof, and/or oxides thereof.

In some embodiments, the solid component can be generated in-situ. In some embodiments, a transition metal solid can be generated in situ within the molten salt(s). In this process, transition metal precursors can be dispersed within the molten salt either homogeneously such as transition metal halide (e.g. CoCl₂, FeCl₂, FeCl₃, NiCl₂, CoBr₂, FeBr₂, FeBr₃, or NiBr₂) dissolved in molten salt, or heterogeneously such as transition metal oxide solid particles (e.g. CoO, Co₃O₄, FeO, Fe₂O₃, Fe₃O₄, NiO) suspended in the molten salt. Hydrogen can then be passed through the mixture and the catalyst precursors can be reduced by the hydrogen. Transition metal solids can be produced and dispersed in the molten salt(s) to form the reaction media for the methane decomposition reactions.

In some embodiments, a multiphase composition can comprise a solid catalytic component. The catalytic solid metal can comprise nickel, iron, cobalt, copper, platinum, ruthenium, or any combination thereof. The solid metals may be on supports such as alumina, zirconia, silica, or any combination thereof. The solids catalytic for hydrocarbon pyrolysis would convert hydrocarbons to carbon and hydrogen and subsequently be contacted with a liquid molten metal and/or molten salt to remove the carbon from the catalyst surface and regenerate catalytic activity. Preferred embodiments of the liquids include but are not limited to molten metals of: nickel-bismuth, copper-bismuth, platinum-bismuth, nickel-indium, copper-indium, copper-lead, nickel-gallium, copper-gallium, iron-gallium, palladium-gallium, platinum-tin, cobalt-tin, bismuth-tin, nickel-tellurium, and/or copper-tellurium. The molten salts can include, but not limited to, NaCl, NaBr, KCl, KBr, LiCl, AlCl₃, LiBr, CaCl₂), MgCl₂, CaBr₂, MgBr₂, and combinations thereof.

The reactor vessel 101 can generally comprise any vessel configured to retain the pressure of the reaction at the reaction temperature. The reactor vessel 101 can be lined with refractory materials to protect the reaction vessel 101 shell. The pyrolysis reaction with the reaction zone 102 can occur under any suitable conditions for pyrolysis to occur. In some embodiments, the temperature can be selected to maintain the molten media in the molten state such that one or more components of the molten media is above the melting point of the mixture while being below the boiling point. In some embodiments, the reactor can be operated at a temperature above about 400° C., above about 500° C., above about 600° C., or above about 700° C. In some embodiments, the reactor can be operated at a temperature below about 1,500° C., below about 1,400° C., below about 1,300° C., below about 1,200° C., below about 1,100° C., or below about 1,000° C.

The reactor can operate at any suitable pressure. The reactor may operate at or near atmospheric pressure such as between about 0.5 atm and about 25 atm, or between about 1 atm and 15 atm. Higher pressures are possible with an appropriate selection of the reactor configuration, operating conditions, and flow schemes, where the pressure can be selected to maintain a gas phase within the reactor. In high pressure embodiments, the feed stream can be introduced into the reactor vessel 101 at a pressure of between 0.1 and 100 bar, and alternatively between 1 and 30 bar.

As described in FIG. 1, a direct contact heat exchanger can be used to transfer heat from the molten media leaving the reaction zone 102 with the feed preheat zone 104 and/or transfer heat from the gaseous products leaving the reaction zone 102 to the molten media in the product exchange zone 106. A number of direct contact heat exchange embodiments are possible. Within the direct contact heat exchangers disclosed herein, a two-phase direct contact between a gas phase and a liquid and/or slurry can occur. In general, the flowrate of the gas phase in these embodiments can be selected independently of the liquid or molten phase flowrate. For example, the liquid phase flow rates are set independently of the gas phase flowrate to operate. In general, the heat exchanger designs can be selected to avoid potential plugging of the gas phase flow paths by any solid carbon entrained in the gas phase products.

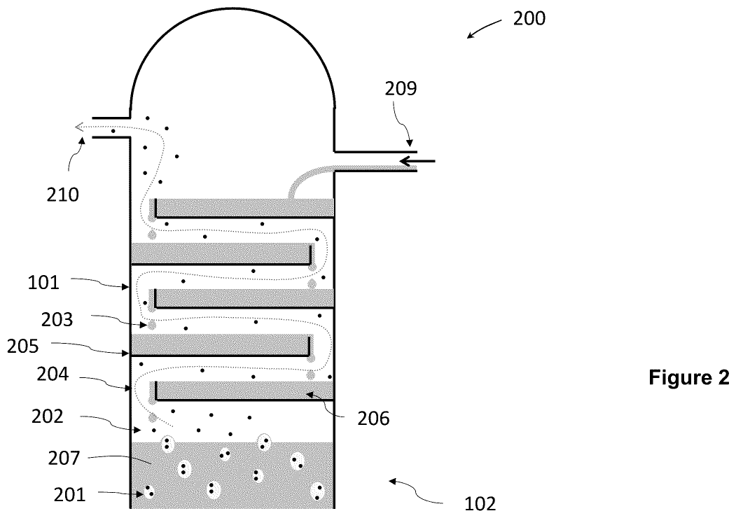

FIG. 2 illustrates an embodiment of a direct contact heat exchanger 200 comprising a plurality of cascading trays 205. The heat exchanger 200 can be used in the feed preheat zone 104 and/or the product exchange zone 106 as described with respect to FIG. 1. In addition, the feed stream, gaseous products, and molten media can include any of those described with respect to FIG. 1. As illustrated, the heat exchanger 200 can comprise a plurality of cascading trays 205. The trays 205 may comprise a weir or dam to retain the molten media 206 on the trays 205 while allowing for the molten media 206 to flow over the weir and pass to the next lower tray 205. The lowest tray 205 can allow the molten media that is heated to pass into the heated molten media 207 in the reaction zone 102. The number of trays can be selected to provide for a desired heat exchange between the gaseous reactants and products 201 and the molten media 206.

The gaseous product flow pathway 204 can pass through the trays such that the gaseous products are forced to pass over the molten media in one tray before passing upwards to pass over the surface of the next tray 205 in series. This provides an extended contact pathway for the gaseous products in order to exchange heat between the molten media 206 and the gaseous products 201. The spacing of the trays 205 and the open areas for gaseous product 201 flow can be selected to provide for a sufficient gas velocity to prevent any carbon particles 202 within the gaseous products from disengaging from the gaseous products 201 or agglomerating on the trays 205 or other surfaces. This can help to avoid plugging while allowing the carbon particles 202 to leave the reactor vessel 101 with the gaseous products 201.

In use, the direct contact heat exchanger as shown in FIG. 2 can operate by allowing the molten media 206 to enter a molten media inlet 209 in an upper section of the reaction vessel 101. The molten media entering the reactor vessel 101 may be cooler than the molten media in the reactor vessel 101, where the temperature may be based on pre-heating the feed in the feed pre-heat zone in the reactor.

The cooled molten media can then be recycled to a top of the reactor vessel 101 using an external line along with a pump or other circulation device. Reference to the upper section can include a top of the reactor or anywhere within about an upper third of the reactor vessel 101. The molten media 206 can pass onto the first tray 205 (e.g., an uppermost tray). The molten media flowrate can cause the molten media to cascade down the plurality of trays 205 serially before finally passing into the reaction zone. For example, the molten media 206 can form droplets 203 or a stream passing over the weir down to the next tray. The weir on each tray 205 can maintain a molten media 206 fluid level present on each tray 205. Further, the use of cascading trays can prevent any backflow or back mixing caused by fluid movement from the gaseous product 201 flow over the molten media 206 on each tray, thereby maintaining a temperature gradient across the upper section of the reactor vessel 101.

The reaction within the reaction zone 102 can generate gaseous products 201 that can contain gas phase products and solid carbon, which may be in the form of carbon particles 202. The gaseous products 201 can pass upwards from the molten media 206 into the flow path created between the plurality of trays 205. The carbon particles 202 can remain entrained in the gaseous products 201 based on the design of the gaseous product flow path 204 to maintain a gas velocity sufficient to keep the carbon particles 202 entrained. The gaseous products 201 with the entrained carbon particles 202 can then pass through a gaseous product outlet 210 in an upper section of the reactor vessel 101. It is expected that the flowrate of the gaseous products may be higher than the volumetric flowrate of the molten media 206. In some aspects, a ratio of the volumetric flowrate of the molten media 206 to that of the gaseous products 201 can be between about 0.001:1 to about 0.1:1.

The resulting contact between the gaseous products 201 and the molten media can act to cool the gaseous products 201 so they can be processed in downstream units such as a carbon separator and recovery unit. An exemplary heat exchange profile is shown in FIG. 2. As an example, the gaseous products 201 and the molten media in the reaction zone 102 can have a temperature of between about 1000° C. and about 1400° C. The incoming molten media may have a temperature between about 400° C. and about 800° C., and the gaseous products leaving the reactor vessel may have a temperature between about 400° C. and about 800° C. The heat exchange effects are illustrated as an example in FIG. 2, which shows the approximate temperature of the molten media 206 on each tray. As shown, the heat exchange can serve to heat the molten media 206 as the molten media 206 approaches the reaction zone 102 while cooling the gaseous products 201 before they leave the reaction vessel 101.

While FIG. 2 illustrates the direct contact heat exchanger having the plurality of cascading trays disposed in an upper portion of the reaction vessel 101 (e.g., in the gaseous product exchange section 106), the same heat exchanger concept can also be used in the feed pre-heat section 104 in some aspects.

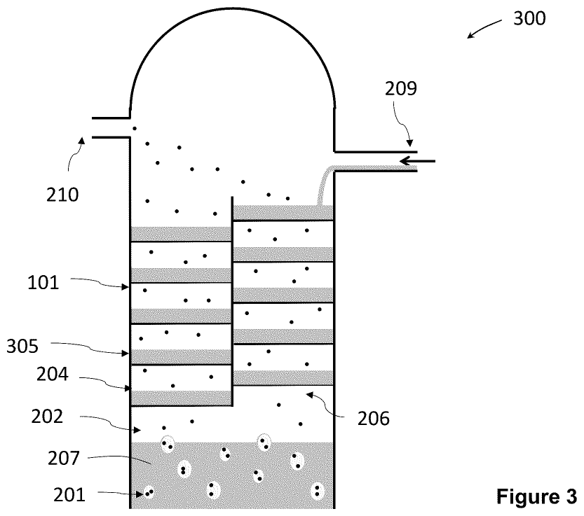

FIG. 3 illustrates another embodiment of a direct contact heat exchanger 300 comprising a plurality of cascading trays 305 having a spiral or helical configuration with the reactor vessel 101. The heat exchanger 300 is similar to the heat exchanger 200 described with respect to FIG. 2, and the same or similar components will not be re-described in the interest of brevity. The heat exchanger 300 can be used in the feed preheat zone 104 and/or the product exchange zone 106 as described with respect to FIG. 1. In addition, the feed stream, gaseous products, and molten media can include any of those described with respect to FIG. 1. As illustrated, the heat exchanger 300 can comprise a plurality of cascading trays 305. The trays can be arranged in a cascade that is arranged in a helical pathway such that the resulting gas flow pathway flows in a helical path upwards from the reaction zone 102. The trays 305 may comprise a weir or dam to retain the molten media 206 on the trays 305 while allowing for the molten media 206 to flow over the weir and pass to the next lower tray 205. The lowest tray 305 can allow the molten media that is heated to pass into the heated molten media 207 in the reaction zone. The number of trays can be selected to provide for a desired heat exchange between the gaseous products 201 and the molten media 206. While shown as extending about a central axis, the trays can have any suitable shape, and may not be aligned about a central axis, though a helical pathway for the molten media 206 and a counterflow of the gas phase can be established.

The gaseous product flow pathway 204 can pass through the helical flow path such that the gaseous products are forced to pass over the molten media in each tray in series along the helical pathway. This provides an extended contact pathway for the gaseous products in order to exchange heat between the molten media 206 and the gaseous products 201. The spacing of the trays 305 and the open areas for gaseous product 201 flow can be selected to provide for a sufficient gas velocity to prevent any carbon particles 202 within the gaseous products from agglomerating on the trays 305 or other surfaces. This can help to avoid plugging while allowing the carbon particles 202 to leave the reactor vessel 101 with the gaseous products 201.

In use, the direct contact heat exchanger as shown in FIG. 3 can operate by allowing the molten media 206 to enter a molten media inlet 209 in an upper section of the reaction vessel 101. The molten media 206 can pass onto the first tray 305 (e.g., an uppermost tray). The molten media flowrate can cause the molten media to cascade down the plurality of trays 305 serially before finally passing into the reaction zone 102. The molten media 206 can pass from one tray to the next in a helical pathway down the plurality of trays 305, and the weirs and configuration of the trays 305 can direct the fluid to the desired location on the next lower tray 305. For example, the molten media 206 can form droplets or a stream passing over the weir down to the next tray. The weir on each tray 205 can maintain a molten media 206 fluid level present on each tray 205. Further, the use of cascading trays can prevent any backflow or back mixing caused by fluid movement from the gaseous product 201 flow over the molten media 206 on each tray. This can result in the molten media 206 on each tray having approximately the same temperature but different temperatures from one tray to an adjacent tray 305.

The gaseous products 201 can pass upwards from the molten media 206 into the flow path created between the plurality of trays 305. The carbon particles 202 can remain entrained in the gaseous products 201 based on the design of the helical gaseous product flow path 204 to maintain a gas velocity sufficient to keep the carbon particles 202 entrained. The gaseous products 201 with the entrained carbon particles 202 can then pass through a gaseous product outlet 210 in an upper section of the reactor vessel 101. It is expected that the flowrate of the gaseous products may be higher than the volumetric flowrate of the molten media 206. In some aspects, a ratio of the volumetric flowrate of the molten media 206 to that of the gaseous products 201 can be between about 0.001:1 to about 0.1:1. While expressed as a ratio, an advantage of the present systems and methods is the ability to set the flowrate of the molten media independently from the gas phase flowrate using the plurality of trays 305.

The resulting contact between the gaseous products 201 and the molten media can act to cool the gaseous products 201 so they can be processed in downstream units such as a carbon separator and recovery unit. An exemplary heat exchange profile is shown in FIG. 3. As an example, the gaseous products 201 and the molten media in the reaction zone 102 can have a temperature of between about 1000° C. and about 1400° C. The incoming molten media may have a temperature between about 400° C. and about 700° C., and the gaseous products leaving the reactor vessel 101 may have a temperature between about 400° C. and about 700° C. The heat exchange effects are illustrated as an example in FIG. 3, which shows the approximate temperature of the molten media 206 on each tray. As shown, the heat exchange can serve to heat the molten media 206 as the molten media 206 approaches the reaction zone 102 while cooling the gaseous products 201 before they leave the reaction vessel 101.

While FIG. 3 illustrates the direct contact heat exchanger having the plurality of cascading trays disposed in an upper portion of the reaction vessel 101 (e.g., in the gaseous product exchange section 106), the same heat exchanger concept can also be used in the feed pre-heat section 104 in some aspects.

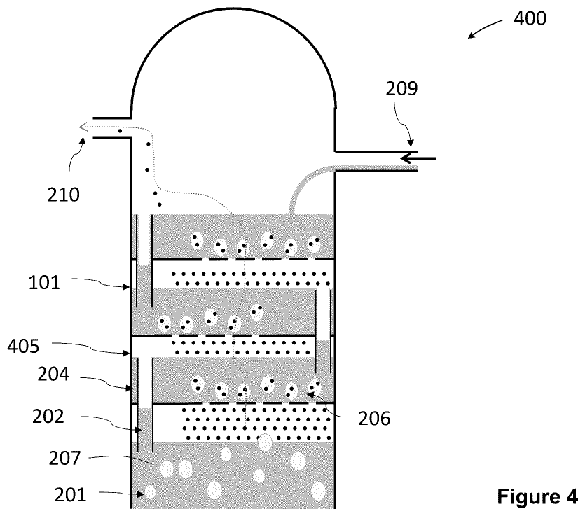

FIG. 4 illustrates an embodiment of a direct contact heat exchanger 400 comprising a plurality of sieve plate trays 405. The heat exchanger 400 is similar to the heat exchanger 200 and the heat exchanger 300 described with respect to FIGS. 2 and 3 in certain respects, and the same or similar components will not be re-described in the interest of brevity. The heat exchanger 400 can be used in the feed preheat zone 104 and/or in the product exchange zone 106 as described with respect to FIG. 1. In addition, the feed stream, gaseous products, and molten media can include any of those described with respect to FIG. 1.

As illustrated, the heat exchanger 400 can comprise a plurality of sieve plate trays 405. The sieve plate trays 405 can comprise a plate having a plurality of holes disposed in the trays. A weir structure can be formed about the sieve plate tray 405 to retain a desired liquid level on each sieve plate tray 405. The weir can allow the molten media 206 to pass over the weir at a desired location and onto the next lower tray, and/or a downcomer can be used to allow the fluid to pass into the next lower tray. The downcomer may generally comprise a pipe or tube of sufficient diameter to provide a flow path for the molten media 206 from one sieve plate tray 405 to the next. A top level of the downcomer may establish the molten media liquid level on a tray, and the lower portion of the downcomer may be disposed below a molten media liquid level on the next lower tray. This can allow liquid to remain in the downcomer to prevent any gas phase flow through the downcomer. The plurality of sieve plate trays 405 can establish a molten media 206 flow path from the top tray to the lowest sieve plate tray 405, whereupon the lowest sieve plate tray 405 can allow the molten media 206 that is heated to pass into the heated molten media 207 in the reaction zone 102. The number of sieve plate trays can be selected to provide for a desired heat exchange between the gaseous products 201 and the molten media 206.

The gas phase flow pathway can pass through the plurality of holes in each sieve plate tray 405. The gas phase passing through the plurality of holes can form bubbles within the molten media 206 on each sieve plate tray 405, pass through the molten media and pass back into a gas phase space above each sieve plate tray 405. This flow path can repeat until the gas phase reaches the uppermost sieve plate tray 405, where the gas phase can pass out of the reactor vessel 101 through the outlet 210. The gas phase passing through the series of sieve plate trays 405 can have an increased contact area between the molten media 206 and the gas phase based on the formation of bubbles on each sieve plate tray 405. This can provide sufficient contact time for the gas phase to contact the molten media 206 in order to exchange heat between the molten media 206 and the gaseous products 201. The spacing of the trays 205, the hole size(s) in the sieve plate trays 405, and the open areas between the sieve plate trays 405 for the gas phase flow flow can be selected to provide for a sufficient gas velocity and flow rate to prevent any carbon particles 202 within the gaseous products from disengaging from the gaseous product stream 210 or agglomerating on the trays 205 or other surfaces. This can help to avoid plugging while allowing the carbon particles 202 to leave the reactor vessel 101 with the gaseous products 201.

In use, the direct contact heat exchanger as shown in FIG. 4 can operate by allowing the molten media 206 to enter a molten media inlet 209 in an upper section of the reaction vessel 101. The molten media 206 flowrate can cause the molten media 206 to pass onto the uppermost sieve plate tray 405. The molten media 206 can pass over a weir or through one or more downcomers to form a cascade down the plurality of sieve plate rays 405 serially before finally passing into the reaction zone 102. For example, the molten media 206 can form a stream passing through the downcomer down to the next tray. Having a lower end of the downcomer below the molten media liquid level on the lower tray can prevent any gas channeling through the downcomer. The downcomer on each sieve plate tray 405 can maintain a molten media 206 fluid level present on each sieve plate tray 405. Further, the use of cascading sieve plate trays 405 can prevent any backflow or back mixing of the molten media 206 between the sieve plate trays 405, thereby allowing for a consistent heat exchange and temperature profile along the sieve plate trays 405.

The gaseous products 201 from the reaction zone 102 can pass upwards from the molten media 206 into the flow path created through the plurality of sieve plate trays 405. For example, the gaseous products 201 can pass through the plurality of holes in the lowermost sieve plate tray 405 and form bubbles through the molten media 206 on the lowermost sieve plate tray 405. Once the bubbles pass through the molten media, the gaseous products 201 can collect in a gas space above the sieve plate tray 405. The process can then repeat through the plurality of holes in each sieve plate tray until the gaseous products 201 collect above the uppermost sieve plate tray 405 before passing out of the reaction vessel 101. The carbon particles 202 can remain entrained in the gaseous products 201 based on the design of the gaseous product flow path 204 to maintain a gas velocity and flow regime sufficient to keep the carbon particles 202 entrained. It is expected that the flowrate of the gaseous products may be higher than the volumetric flowrate of the molten media 206. In some aspects, a ratio of the volumetric flowrate of the molten media 206 to that of the gaseous products 201 can be between about 0.001:1 to about 0.1:1. In the configuration of FIG. 4, the gas flow rate and liquid flow rate can generally be established separately, though a minimum gas phase flowrate may be needed in order to prevent any molten media from passing through the plurality of holes. The size and number of the holes can affect the minimum gas phase flowrate such that the proper design of the holes can be used to allow the flowrate of the molten media 206 and gas phase to be independent without significant molten media flow through the plurality of holes.

The resulting contact between the gaseous products 201 and the molten media 206 can act to cool the gaseous products 201 so they can be processed in downstream units such as a carbon separator and recovery unit. An exemplary heat exchange profile is shown in FIG. 4. As an example, the gaseous products 201 and the molten media in the reaction zone 102 can have a temperature of between about 1000° C. and about 1400° C. The incoming molten media may have a temperature between about 400° C. and about 700° C., and the gaseous products leaving the reactor vessel may have a temperature between about 400° C. and about 700° C. The heat exchange effects are illustrated as an example in FIG. 4, which shows the approximate temperature of the molten media 206 on each sieve plate tray 405. As shown, the heat exchange can serve to heat the molten media 206 as the molten media 206 approaches the reaction zone 102 while cooling the gaseous products 201 before they leave the reaction vessel 101.

While FIG. 4 illustrates the direct contact heat exchanger having the plurality of sieve plate trays 405 disposed in an upper portion of the reaction vessel 101 (e.g., in the gaseous product exchange section 106), the same heat exchanger concept can also be used in the feed pre-heat section 104 in some aspects.

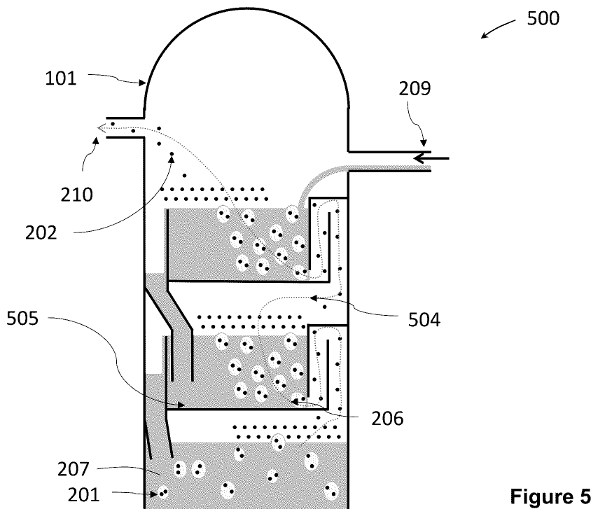

FIG. 5 illustrates an embodiment of a direct contact heat exchanger 500 comprising a plurality of cascading trays 505. The heat exchanger 500 is similar to the heat exchangers described with respect to FIGS. 2-4 in certain respects, and the same or similar components will not be re-described in the interest of brevity. The heat exchanger 500 can be used in the feed preheat zone 104 and/or the product exchange zone 106 as described with respect to FIG. 1. In addition, the feed stream, gaseous products, and molten media can include any of those described with respect to FIG. 1.

As illustrated, the heat exchanger 500 can comprise a plurality of horizontal trays 505. The trays 505 can each have a weir to retain a desired level of molten media 206 on each tray 505. A downcomer can be associated with each tray to collect the molten media 206 passing over each weir and provide a flow path to the next lower tray 505. The lower end of the downcomer can be disposed below a liquid level of the next lower tray, which can prevent any gas flow through the downcomer. The plurality of trays 505 can establish a molten media 206 flow path from the top tray to the lowest tray 505, whereupon the lowest plate tray 505 can allow the molten media 206 that is heated to pass into the heated molten media 207 in the reaction zone 102. The number of trays can be selected to provide for a desired heat exchange between the gaseous products 201 and the molten media 206.

The gas phase flow pathway 504 can pass through the gas manifold in each plate tray 405. The gas phase passing through the gas manifold can form bubbles within the molten media 206 on each plate tray 405, pass through a gas inlet to the bottom of each tray. The gas inlet is configured to prevent any molten media 206 from flow through the gas inlet while directing the gas phase to the lower portion of each tray 505. The gas inlet can be arranged as a manifold, nozzle, sparger, or the like. The gas inlet can allow the gas phase to pass through the molten media 206 with a desired bubble size to provide the desired gas-liquid contact area. This can provide sufficient contact time for the gas phase to contact the molten media 206 in order to exchange heat between the molten media 206 and the gaseous products 201. After passing through the molten media 206, the gas phase can coalesce above the liquid on each tray 505 before passing through a similar gas phase inlet on the next tray 505. This gas phase flow path can continue until the gas phase reaches the top of the reactor vessel 101, where the gas phase can coalesce before passing out of the reactor vessel 101.

The spacing of the trays 505, the gas inlet area on each tray 505, and the open areas between the trays 505 for the gas phase flow can be selected to provide for a sufficient gas velocity and flow rate to prevent any carbon particles 202 within the gaseous products from agglomerating on the trays 505 or other surfaces. This can help to avoid plugging while allowing the carbon particles 202 to leave the reactor vessel 101 with the gaseous products 201.

In use, the direct contact heat exchanger as shown in FIG. 5 can operate by allowing the molten media 206 to enter a molten media inlet 209 in an upper section of the reaction vessel 101. The molten media 206 flowrate can cause the molten media 206 to pass onto the uppermost horizontal tray 505. The molten media 206 can pass over a weir or through one or more downcomers to form a cascade down the plurality of trays 505 serially before finally passing into the reaction zone 102. For example, the molten media 206 can form a stream passing through the downcomer down to the next tray. Having a lower end of the downcomer below the molten media liquid level on the lower tray 505 can prevent any gas channeling through the downcomer. The downcomer on each tray 505 can maintain a molten media 206 fluid level present on each tray 505. Further, the use of cascading trays 505 can prevent any backflow or back mixing of the molten media 206 between the trays 505, thereby allowing for a consistent heat exchange and temperature profile along the plurality of trays 505.

The gaseous products 201 from the reaction zone 102 can pass upwards from the molten media 206 into the flow path created through the plurality of trays 505. For example, the gaseous products 201 can pass through the gas inlet in the lowermost tray 505 and flow into the molten media 206 to form bubbles through the molten media 206 on the lowermost tray 505. Once the bubbles pass through the molten media 206, the gaseous products 201 can collect in a gas space above the tray 505. The process can then repeat through the plurality of trays 505 until the gaseous products 201 collect above the uppermost tray 505 before passing out of the reaction vessel 101. The carbon particles 202 can remain entrained in the gaseous products 201 based on the design of the gaseous product flow path 204 to maintain a gas velocity and flow regime sufficient to keep the carbon particles 202 entrained.

It is expected that the flowrate of the gaseous products may be higher than the volumetric flowrate of the molten media 206. In some aspects, a ratio of the volumetric flowrate of the molten media 206 to that of the gaseous products 201 can be between about 0.001:1 to about 0.1:1. In the configuration of FIG. 5, the gas flow rate and liquid flow rate can generally be established separately as the weir determines the liquid level on each tray 505. The size of the gas manifold can affect the minimum gas phase flowrate such that the proper design of the manifold can be used to allow the flowrate of the molten media 206 and gas phase to be independent without significant molten media flow through the plurality of holes.

The resulting contact between the gaseous products 201 and the molten media 206 can act to cool the gaseous products 201 so they can be processed in downstream units such as a carbon separator and recovery unit. An exemplary heat exchange profile is shown in FIG. 5. As an example, the gaseous products 201 and the molten media in the reaction zone 102 can have a temperature of between about 1000° C. and about 1400° C. The incoming molten media may have a temperature between about 400° C. and about 800° C., and the gaseous products leaving the reactor vessel may have a temperature between about 400° C. and about 800° C. The heat exchange effects are illustrated as an example in FIG. 5, which shows the approximate temperature of the molten media 206 on each tray 505. As shown, the heat exchange can serve to heat the molten media 206 as the molten media 206 approaches the reaction zone 102 while cooling the gaseous products 201 before they leave the reaction vessel 101.

While FIG. 5 illustrates the direct contact heat exchanger having the plurality of horizontal trays 505 disposed in an upper portion of the reaction vessel 101 (e.g., in the gaseous product exchange section 106), the same heat exchanger concept can also be used in the feed pre-heat section 104 in some aspects.

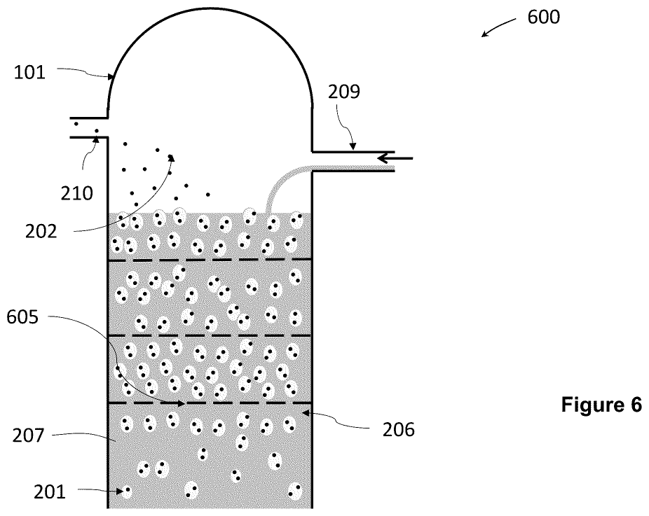

FIG. 6 illustrates an embodiment of a direct contact heat exchanger 600 comprising a plurality of direct contact zones 605 contained between sieve plates to limit axial mixing. Some components of the heat exchanger 600 are similar to the heat exchangers described with respect to FIGS. 2-5 in certain respects, and the same or similar components will not be re-described in the interest of brevity. The heat exchanger 600 can be used in the feed preheat zone 104 and/or the product exchange zone 106 as described with respect to FIG. 1. In addition, the feed stream, gaseous products, and molten media can include any of those described with respect to FIG. 1.

As illustrated, the heat exchanger 600 can comprise a plurality of sieve plates 605, where a volume contained between adjacent sieve plates 605 can define a mixing and heat exchange zone. The area defined by the sieve plates 605 can be flooded with molten media 206 such that there are no defined gas phase zones between the sieve plates 605. In some embodiments, the configuration of the sieve plates 605 and the molten media flowrate can be configured to allow for a defined gas phase zone between at least two sieve plates 605. In this embodiment, the molten media 206 can enter at or above the top sieve tray 605, and the molten media 206 can pass downwards through the plurality of sieve trays 605. In general, the molten media 206 can form the continuous phase within the zones between the sieve trays 605. The lowest sieve plate 605 can define a boundary with the heated molten media 207 in the reaction zone 102. The number of sieve plates 605, the spacing, and the number, size, and arrangement of the holes can be selected to provide for a desired heat exchange between the gaseous products 201 and the molten media 206.

The gas phase flow pathway can pass through the plurality of holes in each sieve plate 605. The gas phase passing through the plurality of holes can form bubbles within the molten media 206 in each heat exchange zone. Within each zone, the flow of the gas phase can cause some axial mixing of the molten media 206 before the bubbles pass upwards through the holes in the next sieve plate 605 and into the next heat exchange zone. The bubbles may not coalesce within each zone before passing into the next heat exchange zone between adjacent sieve plates 605. The gas flowrate, hole size, and number of holes can affect the contact time between the gas phase and the molten media 206 in each heat exchange zone. The contact time can be selected to provide sufficient time to exchange heat between the molten media 206 and the gaseous products 201. After passing through the molten media 206, the gas phase can coalesce above the liquid on the top sieve plate 605, where the gas phase can coalesce before passing out of the reactor vessel 101.

The number, spacing, and hole configuration of the sieve plates 605 can be selected to provide a desired degree of heat exchange and back mixing within each heat exchange zone. As the number of sieve plates 605 increases, the overall heat exchanger approaches a counter-current plug flow design.

In use, the direct contact heat exchanger as shown in FIG. 6 can operate by allowing the molten media 206 to enter a molten media inlet 209 in an upper section of the reaction vessel 101. The molten media 206 flowrate can cause the molten media 206 to pass onto the uppermost sieve plate 605. The molten media 206 can pass through the plurality of holes in the sieve plate 605 into the zone defined between the sieve plate 605 and the next lower sieve plate 605 to form a cascade down the plurality of sieve plates 605 serially before finally passing into the reaction zone 102. For example, the molten media 206 can form a plug flow with some amount of axial mixing in each zone between adjacent plates (and some minor amount between zones) passing through the holes in the sieve plate 605 down to the next zone.

The gaseous products 201 from the reaction zone 102 can pass upwards from the molten media 206 into the flow path created through the holes in the plurality of sieve plates 605. For example, the gaseous products 201 can pass through the holes in the lowermost sieve plate 605 and flow into the molten media 206 to form bubbles through the molten media 206 in the lowermost zone between the lower two sieve plates 605. Once the bubbles pass through the molten media 206, the gaseous products 201 can pass through the holes in the next sieve plate 605 to pass into the next higher zone between the second and third sieve plates 605 as numbered from the lowermost sieve plate 605. The process can then repeat through the plurality of sieve plates 605 until the gaseous products 201 collect above the uppermost sieve plate 605 before passing out of the reaction vessel 101. The carbon particles 202 can remain entrained in the gaseous products 201 based on the design of the gaseous product flow path to maintain a gas velocity and flow regime sufficient to keep the carbon particles 202 entrained in the bubbles. If any carbon enters the molten media, it may separate based on density differences and float to the top of the molten media on or above the uppermost sieve plate 605. As the gas flow passes upwards through the molten media 206, the gas flow may re-entrain the solid carbon to pass the solid carbon out of the reactor vessel 101.

It is expected that the flowrate of the gaseous products may be higher than the volumetric flowrate of the molten media 206. In some aspects, a ratio of the volumetric flowrate of the molten media 206 to that of the gaseous products 201 can be between about 0.001:1 to about 0.1:1. In the configuration of FIG. 6, the gas flow rate and liquid flow rate can generally be established separately.

The resulting contact between the gaseous products 201 and the molten media 206 can act to cool the gaseous products 201 so they can be processed in downstream units such as a carbon separator and recovery unit. An exemplary heat exchange profile is shown in FIG. 6. As an example, the gaseous products 201 and the molten media in the reaction zone 102 can have a temperature of between about 1000° C. and about 1400° C. The incoming molten media may have a temperature between about 400° C. and about 800° C., and the gaseous products leaving the reactor vessel may have a temperature between about 400° C. and about 800° C. The heat exchange effects are illustrated as an example in FIG. 6, which shows the approximate temperature of the molten media 206 on each sieve plate 605. As shown, the heat exchange can serve to heat the molten media 206 as the molten media 206 approaches the reaction zone 102 while cooling the gaseous products 201 before they leave the reaction vessel 101.

While FIG. 6 illustrates the direct contact heat exchanger having the plurality of sieve plates 605 disposed in an upper portion of the reaction vessel 101 (e.g., in the gaseous product exchange section 106), the same heat exchanger configuration can also be used in the feed pre-heat section 104 in some aspects.

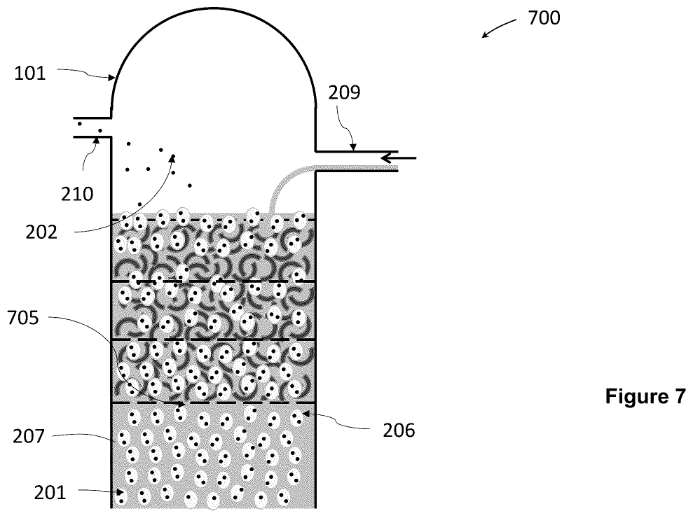

FIG. 7 illustrates an embodiment of a direct contact heat exchanger 700 comprising a plurality of direct contact zones contained between sieve plates 705 to limit axial mixing. Packing can be present between the sieve plates 705 to limit back mixing. Some components of the heat exchanger 700 are similar to the heat exchangers described with respect to FIGS. 2-6 in certain respects, and the same or similar components will not be re-described in the interest of brevity. The heat exchanger 700 can be used in the feed preheat zone 104 and/or the product exchange zone 106 as described with respect to FIG. 1. In addition, the feed stream, gaseous products, and molten media can include any of those described with respect to FIG. 1.

As illustrated, the heat exchanger 700 can comprise a plurality of sieve plates 605, where a volume contained between adjacent sieve plates 705 can define a mixing and heat exchange zone. A packing can be present in each heat exchange zone, and the packing can be supported by a lower sieve plate 705. The packing can comprise any suitable packing such as saddles, rings, spheres, or any other shapes. The packing can be both structured or unstructured, or a combination of the two. The packing can be used to increase a gas holdup in the packing while creating local mixing and a reduction in the bubble sizes flowing through the packing. The area defined by the sieve plates 705 with the packing can be flooded with molten media 206 such that there are no defined gas phase zones between the sieve plates 705. In this embodiment, the molten media 206 can enter at or above the top sieve tray 705, and the molten media 206 can pass downwards through the packing between the plurality of sieve trays 705. In general, the molten media 206 or the gas can form the continuous phase within the zones between the sieve trays 705. For example, the molten media 206 can generally coat the packing and the gas phase can form a discontinuous phase through the packing. Alternatively, the gas can generally be continuous and the liquid phase can form a discontinuous phase through the packing. The lowest sieve plate 705 can define a boundary with the heated molten media 207 in the reaction zone 102. The number of sieve plates 705, the spacing, the number, size, and arrangement of the holes, and the selection and size of the packing can be selected to provide for a desired heat exchange between the gaseous products 201 and the molten media 206.

The gas phase flow pathway can pass through the plurality of holes in each sieve plate 605. The gas phase passing through the plurality of holes can form bubbles within the molten media 206 in each heat exchange zone. As the bubbles pass through the molten media 206 and the packing, the packing can create localized mixing through an increased flow path defined between the packing elements. Within each zone, the flow of the gas phase can cause some axial mixing of the molten media 206 before the bubbles pass upwards through the holes in the next sieve plate 705 and into the next heat exchange zone. The presence of the packing may help to further limit any axial mixing between the adjacent heat exchange zones. The bubbles may not coalesce within each zone before passing into the next heat exchange zone between adjacent sieve plates 705. The gas flowrate, hole size, number of holes, and the selection and size of the packing can affect the contact time between the gas phase and the molten media 206 in each heat exchange zone. The contact time can be selected to provide sufficient time to exchange heat between the molten media 206 and the gaseous products 201. After passing through the molten media 206, the gas phase can coalesce above the molten media on the top sieve plate 705, where the gas phase can coalesce before passing out of the reactor vessel 101.

The spacing of the sieve plates 705 and the selection of the packing can be selected to provide a desired degree of heat exchange within each heat exchange zone. The presence of the packing may limit the need for an increased number of sieve plates 705 as the packing may serve to limit any axial mixing within the heat exchange zones.

In use, the direct contact heat exchanger as shown in FIG. 7 can operate by allowing the molten media 206 to enter a molten media inlet 209 in an upper section of the reaction vessel 101. The molten media 206 flowrate can cause the molten media 206 to pass onto the uppermost sieve plate 705. The molten media 206 can pass through the plurality of holes in the sieve plate 705 into the zone defined between the sieve plate 705 and the next lower sieve plate 705 to form a cascade down the plurality of sieve plates 705 serially before finally passing into the reaction zone 102. Within each heat exchange zone, the molten media 206 can pass over and through a bed of packing to form an increased molten media flow path.

The gaseous products 201 from the reaction zone 102 can pass upwards from the molten media 206 into the flow path created through the holes in the plurality of sieve plates 705. For example, the gaseous products 201 can pass through the holes in the lowermost sieve plate 705 and flow into the molten media 206 to form bubbles through the molten media 206 in the lowermost zone between the lower two sieve plates 705. Within the heat exchange zone, the gas can flow through a plurality of tortuous flow paths created through the packing. The packing can create an increased gas phase flow path while also creating localized mixing. The packing may also control the bubble size passing through the packing such that the bubble size can be maintained at a desired size through the packing. Once the bubbles pass through the packing and the molten media 206, the gaseous products 201 can pass through the holes in the next sieve plate 705 to pass into the next higher zone between the second and third sieve plates 705 as numbered from the lowermost sieve plate 705. The process can then repeat through the plurality of sieve plates 705 and packings until the gaseous products 201 collect above the uppermost sieve plate 705 before passing out of the reaction vessel 101. The carbon particles 202 can remain entrained in the gaseous products 201 based on the design of the gaseous product flow path 204 to maintain a gas velocity and flow regime sufficient to keep the carbon particles 202 entrained in the bubbles. If any carbon enters the molten media, it may separate based on density differences and float to the top of the molten media on or above the uppermost sieve plate 705. As the gas flow passes upwards through the molten media 206, the gas flow may re-entrain the solid carbon to pass the solid carbon out of the reactor vessel 101.

It is expected that the flowrate of the gaseous products may be higher than the volumetric flowrate of the molten media 206. In some aspects, a ratio of the volumetric flowrate of the molten media 206 to that of the gaseous products 201 can be between about 0.001:1 to about 0.1:1. In the configuration of FIG. 7, the gas flow rate and liquid flow rate can generally be established separately. For example, the flow rate of the molten media 206 is not dependent upon the flow rate of the gas phase.

The resulting contact between the gaseous products 201 and the molten media 206 can act to cool the gaseous products 201 so that the gas phase can be processed in downstream units such as a carbon separator and recovery unit. An exemplary heat exchange profile is shown in FIG. 7. As an example, the gaseous products 201 and the molten media in the reaction zone 102 can have a temperature of between about 1000° C. and about 1400° C. The incoming molten media may have a temperature between about 400° C. and about 800° C., and the gaseous products leaving the reactor vessel may have a temperature between about 400° C. and about 800° C. The heat exchange effects are illustrated as an example in FIG. 7, which shows the approximate temperature of the molten media 206 on each sieve plate 705. As shown, the heat exchange can serve to heat the molten media 206 as the molten media 206 approaches the reaction zone 102 while cooling the gaseous products 201 before they leave the reaction vessel 101.

While FIG. 7 illustrates the direct contact heat exchanger having the plurality of sieve plates 705 disposed in an upper portion of the reaction vessel 101 (e.g., in the gaseous product exchange section 106), the same heat exchanger configuration can also be used in the feed pre-heat section 104 in some aspects.

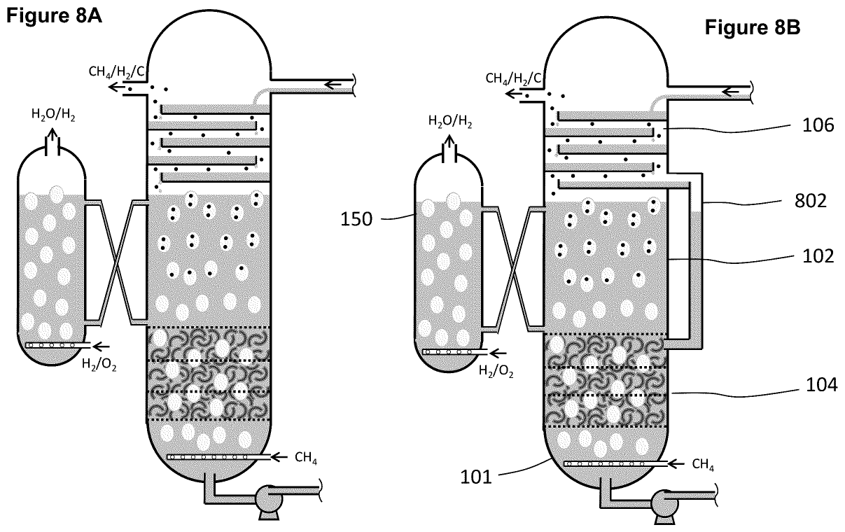

FIGS. 8A and 8B illustrate schematic reactor designs. The designs in FIGS. 8A and 8B are similar to the design illustrated in FIG. 1, and like components can be the same or similar to those described in FIG. 1. As shown in FIG. 8A, a central reaction zone 102 can be present at or near the center of the reactor vessel 101. A lower feed pre-heat zone 104 can be located below the reaction zone 102, and an upper product heat exchange zone 106 can be located above the reaction zone 102. Within the reactor, a feed comprising a reactant gas can enter through the inlet 108. A sparger or other distributor can be used to provide the feed gas into the reactor vessel 101, which may be in the form of bubbles or a gas stream in contact with the molten media. The feed gas can pass through the feed pre-heat zone 104 in a counter current flow to the molten media, which can pass out of the reactor vessel 101 through a molten media outlet 114. The feed pre-heat zone 104 can include elements of any of the direct contact heat exchanger designs described with respect to FIGS. 2-7. Within feed pre-heat zone 104, the feed can exchange heat with the molten media leaving the reaction zone 102 to pre-heat the feed gases. In some aspects, the feed may be pre-heated outside of the reactor vessel 101 and may enter the reactor vessel 101 at a temperature between about 200° C. and about 600° C. Within feed pre-heat zone 104, the feed gas can be heated to a reaction temperature before entering the reaction zone 102.

Within the reaction zone 102, the feed gas can contact the molten media to convert at least a portion of the reactants, which can comprise hydrocarbons, into solid carbon and a gas phase product as described with respect to FIG. 1. In order to maintain the molten media temperature within the reaction zone, a variety of heat exchanger options are available. As shown in FIG. 1, an external heat exchanger 150 can be used to receive a portion of the molten media from the product exchange zone 106 and/or an upper portion of the reaction zone 102, heat the molten media, and return the molten media to a lower portion of the reaction zone 102 and/or an upper portion of the feed pre-heat zone 104. This configuration can allow the feed gas and molten media to have a co-current flow within the reaction zone 102, while the gas phase and molten media phases in the feed pre-heat zone 104 and the product exchange zone 106 can have a counter-current flow. Within the product exchange zone 106, the gaseous products leaving the reaction zone 102 can exchange heat with the molten media entering the reaction zone 102, also as described with respect to FIG. 1. Any of the direct contact heat exchangers as described with respect to FIGS. 2-7 can be used in the product exchange zone 106.

As shown in FIG. 8A, the external heat exchange for the reaction zone 102 can receive molten media from within the reaction zone 102, heat the molten media, and pass the molten media back to the reaction zone 102. The molten media can include media entering from the product exchange zone 106, and a portion of the molten media from the reaction zone 102 can pass down to the feed pre-heat zone 104. In this configuration, at least some of the molten media may circulate back from the feed pre-heat zone 104 to the product exchange zone 106, and through the reaction zone 102.

FIG. 8B illustrates an embodiment in which a bypass 802 is used to pass the majority of the molten media from the product exchange zone 106 around the reaction zone 102 and into the feed pre-heat zone 104. The molten media within the reaction zone 102 may be heated and maintained at temperature using the heater. The feed pre-heat zone 104 may not be isolated from the reaction zone 102 such that some minor amount of axial mixing of the molten media between the feed pre-heat zone 104 and the reaction zone 102 may occur. This configuration may be useful in allowing the heat source used to heat the molten media in the reaction zone 102 to maintain the high temperature of reaction in the reaction zone 102 without needing to supply heat to the molten media used for direct contact heat exchange with the feed and the reaction products.

Within the reaction zone 102, the molten media temperature can be maintained by various heater designs and configurations. FIGS. 8A and 8B illustrate an external heater design. In this embodiment, a combustible gas can be introduced into the molten media withdrawn from the reaction zone 102. For example, the combustible gas can comprise a hydrocarbon and/or hydrogen. An oxygen containing gas including but not limited to air, air enriched in O₂, or O₂ can also be introduced to provide for combustion of the combustible gas to produce heat. An excess of combustible gas can be used to ensure complete reaction of the oxygen. For a molten metal system, the excess of combustible gas required is determined by the appropriate H₂/H₂O and CO/CO₂ ratios in the product gas to ensure a thermodynamically unstable metal-oxide formation. The ratio of hydrocarbon and/or hydrogen to oxygen is specific to the molten media and can vary greatly. The resulting reaction products in the heater can include water only when hydrogen is used as the combustible gas, or water, carbon monoxide, and carbon dioxide when a hydrocarbon is used. The use of a portion of the hydrogen product to heat the molten media then has the advantage of avoiding the creation of carbon dioxide within the process. The combustion gases can flow upwards within the molten media in the heater, which can create a bubble lift to circulate the molten media to the top of the heater, whereupon the heated molten media can flow back to a lower portion of the reaction zone 102. This process can then serve to heat the molten media within the reaction zone 102 while also providing for a bubble lift to circulate the media between the heater and the reaction zone.

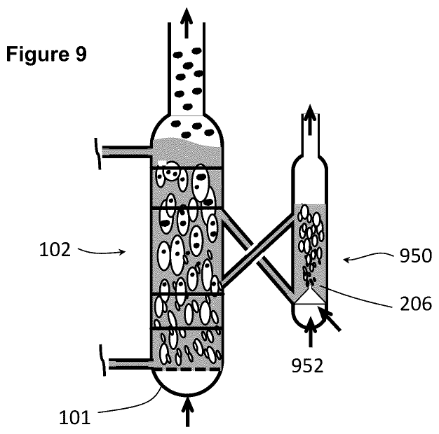

FIG. 9 illustrates another embodiment of an external heater 950 for use in maintaining and/or heating the molten media used in the reaction zone 102. The molten media 206 heater 950 is similar to the external heater 150 described with respect to FIG. 1, and the heaters described with respect to FIGS. 8A and 8B. The same or similar components are not re-described in the interest of brevity. Further, the heater 950 of FIG. 9 can be used with any of the configurations and direct contact heat exchangers described with respect to FIGS. 1-8B.

As shown in FIG. 9, a heater 950 can be fluidly coupled to the reaction zone 102 in the reactor vessel 101. The fluid connections can provide for co-current flow of the reactants in the feed and the molten media within the reaction zone 102. For example, the rising gas reactants and gaseous products can flow along with the molten media 206 within the reaction zone 102. A heater supply line can draw molten media off of the top or near the top of the reaction zone 102, and a heater return line can provide heated molten media back to a lower portion or the bottom of the reaction zone 102. The molten media 206 can be provided to a lower portion of the heater 950. Within the heater 950, the molten media can be heated and rise to pass through the heater return line.

As shown in FIG. 9, the molten media can be heated through the use of a combustible gas, which is similar to the embodiment shown in FIGS. 8A and 8B. As illustrated, a combustible gas 952 can be introduced along with a source of oxygen into a combustion chamber in a lower portion of the heater 950. The combustion of the gas can result in reaction products formed in the heater including water only when hydrogen is used as the combustible gas, or water, carbon monoxide and carbon dioxide when a hydrocarbon is used. Some amount of unreacted gas can also be present in the combustion products. For a molten metal system, the excess of combustible gas required is determined by the appropriate H₂/H₂O and CO/CO₂ ratios in the product gas to ensure a thermodynamically unstable metal-oxide formation. The ratio hydrocarbon and/or hydrogen to oxygen is specific to the molten media and can vary greatly. The combustion gases can flow through a nozzle into the molten media to form a gaseous jet. The jet can result in the formation of bubbles of the combustion gas providing heat to the molten media. The outlet of the nozzle along with the natural lift of the bubbles can drive the molten media from the nozzle towards the heater return line. This process can then serve to heat the molten media within the reaction zone 102 while also providing for a bubble lift to circulate the media within the heater to the reaction zone. The temperature of the molten media can be controlled based on the amount of combustible reactants provided to the heater 950. Further, the combustion gases can be processed separately from the gaseous reaction products based on being present in a separate heater 950. This can provide for the need for simpler and/or smaller separation processes to handle each gas stream.

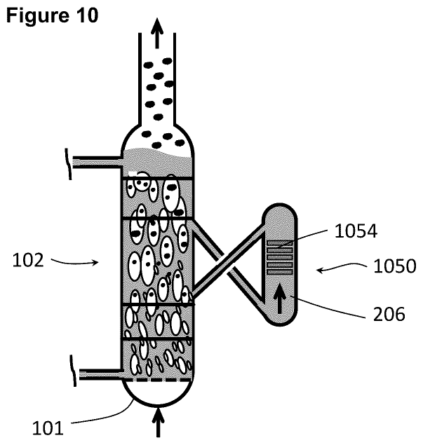

FIG. 10 illustrates another embodiment of an external heater 1050 for use in maintaining and/or heating the molten media 206 used in the reaction zone 102. The molten media 206 heater 1050 is similar to the external heater 150 described with respect to FIG. 1, the heaters described with respect to FIGS. 8A and 8B, and the heater 950 described with respect to FIG. 9. The same or similar components are not re-described in the interest of brevity. Further, the heater 1050 of FIG. 10 can be used with any of the configurations and direct contact heat exchangers described with respect to FIGS. 1-8B

As shown in FIG. 10, a heater 1050 can be fluidly coupled to the reaction zone 102 in the reactor vessel 101. The fluid connections can provide for co-current flow of the reactants in the feed and the molten media within the reaction zone 102. A heater supply line can draw molten media off of the top or near the top of the reaction zone 102, and a heater return line can provide heated molten media back to a lower portion or the bottom of the reaction zone 102. The molten media 206 can be provided to a lower portion of the heater 1050. Within the heater 1050, the molten media can be heated and rise to pass through the heater return line.

As shown in FIG. 10, the molten media can be heated through the use of an electric heater element 1054 disposed in direct contact with the molten media 206 in the heater 1050. As shown, one or more heating elements can be placed within the heater 1050 at any location. In some embodiments, a plurality of heater elements 1054 can be present along the length of the heater 1050, where the temperature can be increased due to direct contact with the heating elements 1054. In this embodiment, there are no active fluid pumps or gas lifts within the separate heater 1050. Rather, the heater 1050 can rely on natural convection to transport the molten media 206 through the heater 1050 and return the heated molten media 206 to the reactor vessel 101 as well as the fluid circulation within the reaction zone 102 of the reactor vessel 101 driven by the gas lift. The use of electrical heating elements may eliminate the creation of any combustion products in the heater 1050, which may further simplify the system. In some embodiments, a plurality of external heaters 1050 can be provided in fluid communication with the reaction zone 102 to heat the molten media. For example, a plurality of heaters 1050 using electrical heat elements can be fluidly coupled to the reaction zone in parallel to provide heat to the molten media. Such an embodiment may provide redundancy and/or more even heat and temperature control to the molten media in the reaction zone 102.

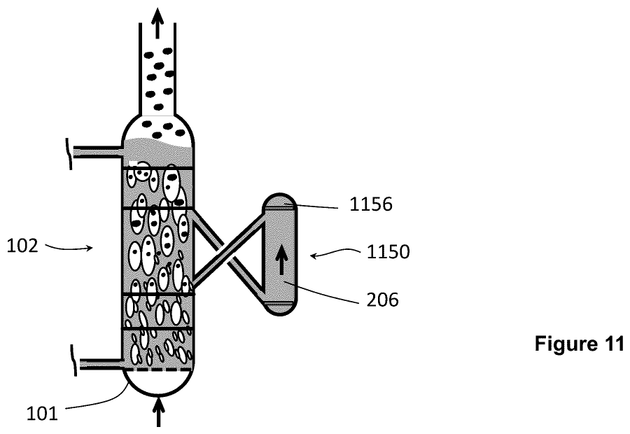

FIG. 11 illustrates another embodiment of an external heater 1150 for use in maintaining and/or heating the molten media 206 used in the reaction zone 102. The molten media 206 heater 1150 is similar to the external heater 150 described with respect to FIG. 1, the heaters described with respect to FIGS. 8A and 8B, the heater 950 described with respect to FIG. 9, and the heater 1050 described with respect to FIG. 10. The same or similar components are not re-described in the interest of brevity. Further, the heater 1150 of FIG. 11 can be used with any of the configurations and direct contact heat exchangers described with respect to FIGS. 1-8B.

As shown in FIG. 11, a heater 1150 can be fluidly coupled to the reaction zone 102 in the reactor vessel 101. The fluid connections can provide for co-current flow of the reactants in the feed and the molten media within the reaction zone 102. A heater supply line can draw molten media off of the top or near the top of the reaction zone 102, and a heater return line can provide heated molten media back to a lower portion or the bottom of the reaction zone 102. The molten media 206 can be provided to a lower portion of the heater 1150. Within the heater 1150, the molten media can be heated and rise to pass through the heater return line.

As shown in FIG. 11, the molten media can be heated through the use of Joule or resistive heating using electrodes 1156 in contact with the molten media 206 in the heater 1150. As shown, a pair of electrodes can be present at an upper and lower portion of the heater 1150. A current can be passed through the molten media, which can result in heating of the molten media 206. In some embodiments, a plurality of electrodes 1156 in appropriately spaced pairs can be present along the length of the heater 1150. In this embodiment, there are no active fluid pumps or gas lifts in the external heater. Rather, the heater 1150 can rely on natural convection to transport the molten media 206 through the heater 1150 and return the heated molten media 206 to the reactor vessel 101 as well as the fluid circulation within the reaction zone 102 of the reactor vessel 101 driven by the gas lift. The use of resistive heating elements may eliminate the creation of any combustion products in the heater 1150, which may further simplify the system. In some embodiments, a plurality of heaters 1150 can be provided in fluid communication with the reaction zone 102 to heat the molten media. For example, a plurality of heaters 1150 using resistive heat elements can be fluidly coupled to the reaction zone in parallel to provide heat to the molten media. Such an embodiment may provide redundancy and/or more even heat and temperature control to the molten media in the reaction zone 102.

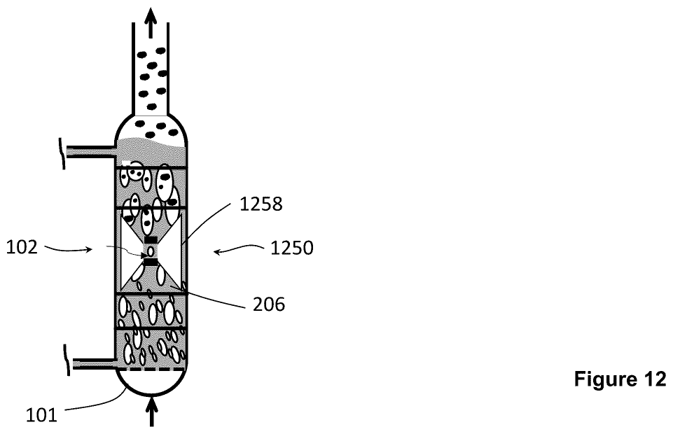

FIG. 12 illustrates another embodiment of a heater 1250 for use in maintaining and/or heating the molten media 206 in the reaction zone 102. The molten media 206 heater 1250 is similar to the external heater 150 described with respect to FIG. 1, the heaters described with respect to FIGS. 8A and 8B, the heater 950 described with respect to FIG. 9, the heater 1050 described with respect to FIG. 10, and the heater 1150 described with respect to FIG. 11, except that the heater 1250 is disposed within the reaction zone 102. The same or similar components are not re-described in the interest of brevity. Further, the heater 1250 of FIG. 12 can be used with any of the configurations and direct contact heat exchangers described with respect to FIGS. 1-8B.

As shown in FIG. 12, a heater 1250 is disposed within the reaction zone 102. An insert 1258 can be provided within the reaction zone 102 to direct flow through the reaction zone 102 in a co-current flow pattern. For example, the insert 1258 can have a lower portion arranged in a cone or funnel shape to direct the molten media along with the reactant gases upwards towards the center of the reaction zone. A central reaction heated zone can be heated to initiate the reaction of the reactants in the molten media. The gaseous products, any unreacted feed, and the molten media can then pass upwards in a co-current flow towards the top of the reaction zone 102. An annular flow channel can be formed between the insert 1258 and the internal wall of the reactor vessel 101. The molten media can flow down along the reaction vessel 101 wall to return to a lower portion of the reaction zone, where the feed gas can entrain the molten media to recirculate the molten media through the central reaction heated zone. The remaining portions of the reactor can be the same as those described herein.

The internal heater can be used to heat the molten media within the central reaction heated zone. A number of heating elements such as electrical heating elements or Joule electrodes to produce resistively heated molten media within the central reaction heated zone can be used. FIG. 12 shows the use of electrodes to produce a hot zone at or above a pyrolysis reaction temperature within the insert. The use of the electrodes and resistive heating is the same or similar to the Joule heating described with respect to FIG. 11, except that the heating is carried out within the reaction zone 102 rather than in an external heater. Since the feed gas is channeled to this heated zone, the pyrolysis reaction can be carried out within the central reaction heated zone. The use of an internal heater may further simplify the reactor design by avoiding any external piping, connections, and external heater vessels.

Within the embodiments disclosed herein, the molten media can be recirculated through an external loop from a lower portion of the reaction vessel 101 to a molten media inlet in an upper portion of the reaction vessel 101. The use of the direct contact heat exchangers as described herein can provide for effective cooling of the molten media before the molten media leaves the reaction vessel. This can then allow for various configurations to be used to circulate the molten media in an external circulation loop back to a top portion of the reaction vessel 101. In some embodiments, any suitable circulation mechanism can be used to cause the molten media to flow from a molten media outlet in a lower portion of the reaction vessel to a molten media inlet in an upper portion of the reaction vessel 101.

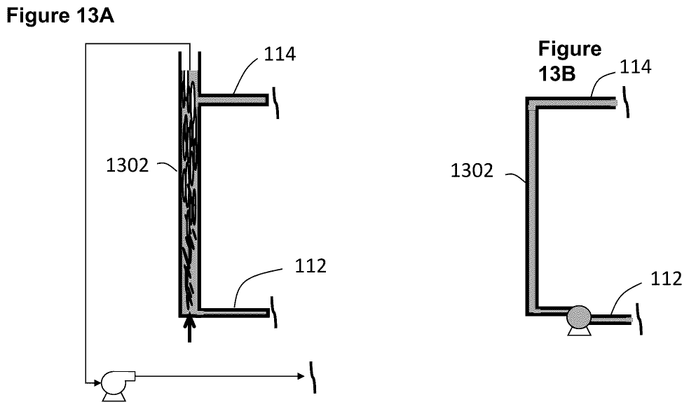

FIGS. 13A and 13B illustrate different molten media circulation configuration according to some embodiments. For example, FIG. 13A illustrates the molten media circulation line 1302 circulating the molten media between the molten media outlet 112 and the molten media outlet 114. In this configuration, the molten media can be circulated using a bubble lift design. In some embodiments, a gas can be introduced into the molten media to create a molten media circulation up to the molten media inlet 114. An upper gas space can be created in the recirculation line 1302 to allow the gas to disengage from the molten media and be collected for further use. The gas used can come from a variety of sources. In some embodiments, the gas used to create the molten media flow can be at least a portion of the feed gas, and the introduction into the molten media circulation line 1302 can be used to heat the feed to the reactor vessel. The molten media in the molten media circulation line 1302 may be cool enough that any significant pyrolysis of the feed gas can be avoided. Even if some amount of reaction takes place, the resulting product gases can then be fed back to the reactor vessel 101 for processing with the remaining gaseous products. In some embodiments, the gas can be a portion of the product gases, where the contact with the molten media in the molten media circulation line 1302 can further cool the product gases. In still other embodiments, hydrogen or another gas from within the system can be used to create the bubble lift within the molten media circulation line 1302. The relatively low flow rate of the molten media used within the system may allow the bubble lift to work, and the flow rate can be controlled through control of the gas phase flow rate through the molten media recirculation line 1302.

FIG. 13B illustrates a similar recirculation concept using a pump or other motive device. The molten media in the molten media recirculation line 1302 may be cool enough that a convention pump can be used to drive the flow of the molten media. Further, a relatively low flow rate of the molten media could use or rely on a small pump to create the desired flow rate of the molten media through the molten media recirculation line 1302.

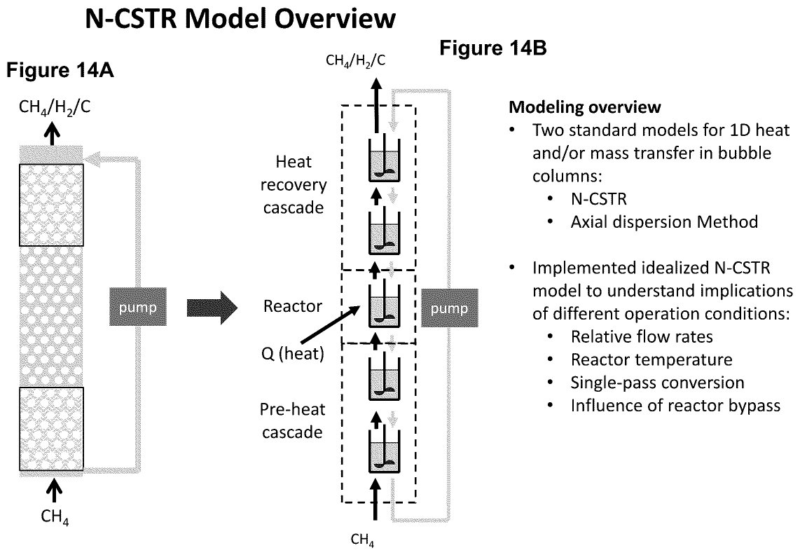

As an example of the configurations for the molten media reactor as described herein, a series of models were created to demonstrate the various temperature profiles within the reactor. FIG. 14A shows the modeled system comprising a feed pre-heat zone 104, a reactor section 102, and a gaseous product exchange section 106. The molten media can be recirculated from a lower portion of the reactor to an upper portion of the reactor. FIG. 14B illustrates the model. The model represents two standard models for 1-D heat and/or mass transfer including an N-CSTR (N continuous stirred tank reactors in series) model, and an axial dispersion model. The idealized N-CSTR model was used to understand the implications of different operating conditions including relative flow rates, reactor temperatures, single-pass conversions, and the influence of a reactor bypass (e.g., from the upper gaseous product exchange section to the lower feed pre-heat section).

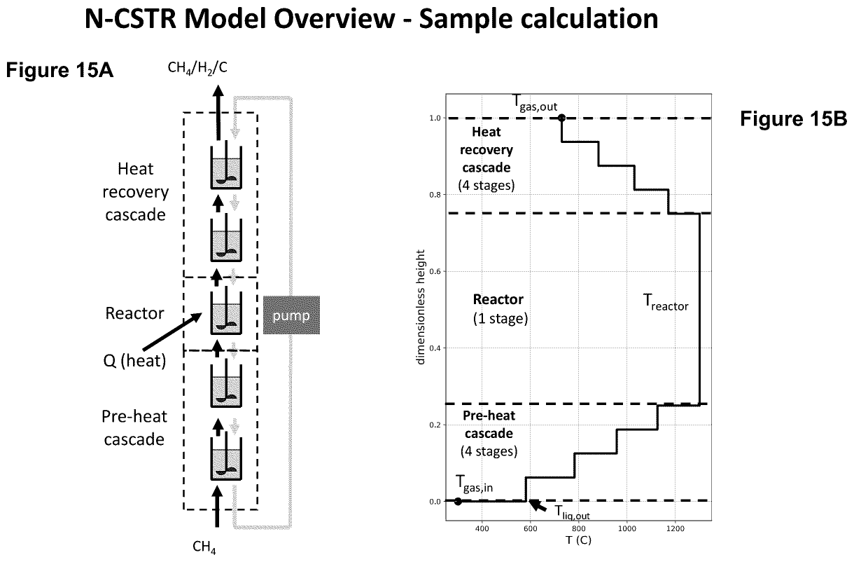

The resulting model calculations for the N-CSTR model are shown in FIG. 15B where the modeled system is shown in FIG. 15A along the results. As shown in FIG. 15B, the temperature can be controlled and increased in the direct contact heat exchangers in both the feed pre-heat section 104 and the gaseous product exchange section 106 to produce a reaction temperature within the reaction zone 102.

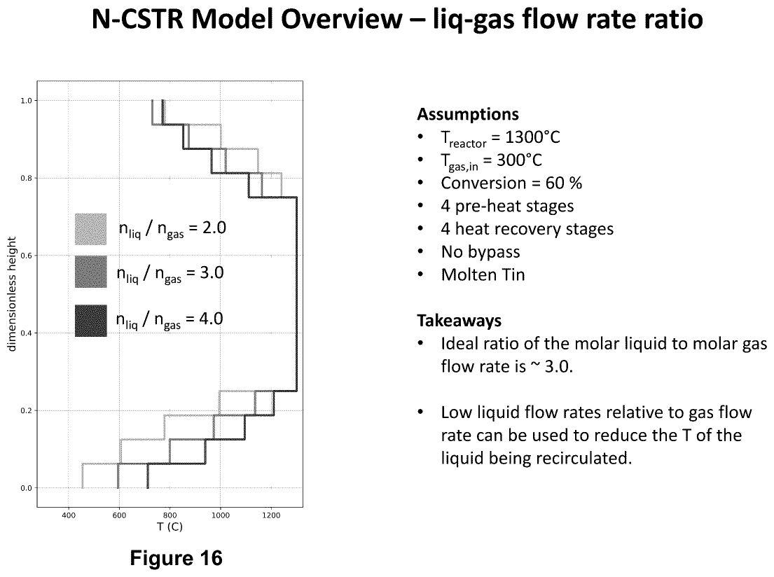

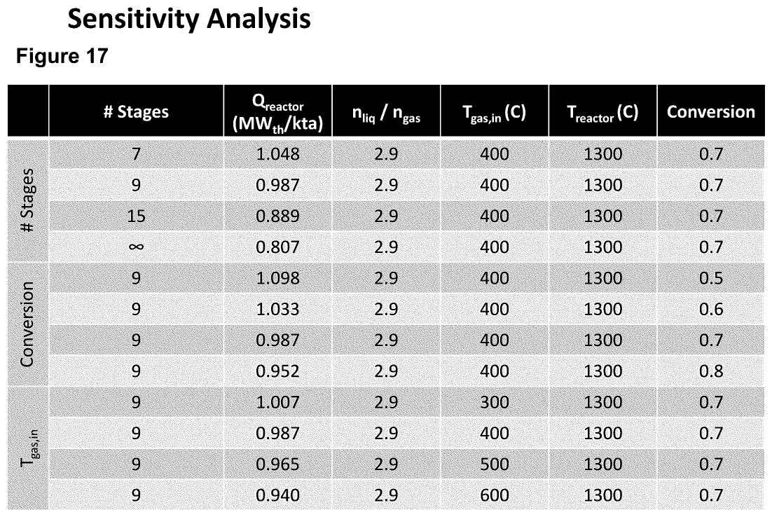

The relative temperature changes along each theoretical CSTR is shown in FIG. 16 at varying molar flowrates of the liquid to the feed gas. As shown, the model assumed a reaction temperature of 1300° C., a feed gas inlet temperature of 300° C., a conversion in the reaction zone 102 of 60%, the use of 4 pre-heat stages, 4 heat recovery stages, and no bypass around the reactor. The molten media modeled was molten tin. Molar flow ratios of molten liquid to feed gas were modeled at ratios of 2:1, 3:1, and 4:1. As shown, a lower liquid flowrate helped to reduce the outlet temperature of the molten media, thereby simplifying the recirculation of the molten media to the top of the reactor. A higher liquid flowrate resulted in a higher molten media outlet temperature. This model then demonstrates that the molar flow rate may be selected to be in the range of 2:1 to 4:1 or about 3:1 with regard to the ratio of the molar flow rate of the liquid to the molar flow rate of the gas. As part of the modeling, FIG. 17 demonstrates the effects of changes in the number of theoretical stages, the conversion, and the temperature of the feed gas into the reactor vessel.

Having described various systems and methods, certain aspect can include, but are not limited to:

In a first aspect, a direct contact heat exchanger for a molten media reactor comprises: a plurality of trays or stages disposed in a vessel; a molten media flow path configured to pass a molten media through the plurality of trays or stages; and a gas pathway disposed through the plurality of trays or stages, wherein the gas pathway is configured to directly contact a gas phase fluid with the molten media on the plurality of trays or stages.

A second aspect can include the exchanger of the first aspect, further comprising: a molten media disposed within the plurality of trays or stages on the molten media flow path.

A third aspect can include the exchanger of the first or second aspect, wherein the plurality of trays or stages comprise a plurality of cascading trays, wherein each tray of the plurality of cascading trays comprises a weir configured to retain the molten media on each tray.

A fourth aspect can include the exchanger of the third aspect, wherein the plurality of cascading trays are arranged in a staggered configuration.

A fifth aspect can include the exchanger of the third or fourth aspect, wherein the gas pathway passes over the surface of a first tray of the plurality of cascading trays before passing over a surface of a second tray of the plurality of cascading trays, wherein the second tray is above the first tray.

A sixth aspect can include the exchanger of any one of the first to fifth aspects, wherein the plurality of trays or stages comprise a plurality of cascading trays arranged in a spiral configuration.

A seventh aspect can include the exchanger of the sixth aspect, wherein the gas pathway passes over a surface of each tray of the plurality of cascading trays in a spiral pathway through the vessel.

An eighth aspect can include the exchanger of the first or second aspect, wherein the plurality of trays or stages comprise a plurality of sieve trays, wherein each sieve tray of the plurality of sieve trays comprise one or more holes.

A ninth aspect can include the exchanger of the eighth aspect, further comprising: a downcomer disposed through each sieve tray, wherein the downcomer has an upper end above a surface of the sieve tray configured to retain a level of the molten media on the sieve tray, and where the downcomer has a lower end disposed below a liquid level of a second sieve tray below the sieve tray.

A tenth aspect can include the exchanger of the eighth or ninth aspect, wherein the gas pathway is defined through the one or more holes in each sieve tray of the plurality of sieve trays.

An eleventh aspect can include the exchanger of the first or second aspect, wherein the plurality of trays or stages comprise a plurality of cascading trays, where a gas inlet is disposed along an upper surface of each tray of the plurality of cascading trays, and wherein a downcomer is disposed through each tray.

A twelfth aspect can include the exchanger of the eleventh aspect, wherein the gas inlet comprises a nozzle, jet, sparger, manifold, or a combination thereof.

A thirteenth aspect can include the exchanger of the eleventh or twelfth aspect, wherein the gas pathway passes over a surface of the molten media on a first tray, through the gas inlet on a second tray, and through the molten media on the second tray, wherein the second tray is above the first tray.

A fourteenth aspect can include the exchanger of the first or second aspect, wherein the plurality of trays or stages comprise a plurality of sieve trays, wherein each sieve tray of the plurality of sieve trays comprise one or more holes, and wherein the plurality of sieve trays are configured to be flooded with the molten media.

A fifteenth aspect can include the exchanger of the fourteenth aspect, wherein the gas pathway is disposed through the one or more holes in each sieve tray of the plurality of sieve trays.

A sixteenth aspect can include the exchanger of the fourteenth or fifteenth aspect, further comprising: a packing disposed between adjacent sieve trays of the plurality of sieve trays, wherein the gas pathway is configured to pass through the packing.

In a seventeenth aspect, a method of exchanging heat in a molten media reactor comprises: passing a molten media through a plurality of trays or stages in a reactor vessel; passing a gas phase fluid through a gas pathway through the plurality of trays or stages; and contacting the molten media with a gas phase fluid within the reactor vessel, wherein the gas phase fluid directly contacts the molten media on the plurality of trays or stages.

An eighteenth aspect can include the method of the seventeenth aspect, wherein the molten media comprises a molten metal, a molten salt, or any combination thereof.

A nineteenth aspect can include the method of the seventeenth or eighteenth aspect, wherein the plurality of trays or stages comprises a plurality of cascading trays, and wherein the method further comprises: retaining a level of molten media on each tray of the plurality of trays or stages using a weir; and passing the molten media from a first tray of the plurality of cascading trays to a second tray of the plurality of cascading trays, wherein the first tray is above the second tray.

A twentieth aspect can include the method of the nineteenth aspect, wherein the plurality of cascading trays are arranged in a staggered configuration.

A twenty first aspect can include the method of the nineteenth or twentieth aspect, wherein passing the gas phase fluid through the gas pathway comprises: passing the gas phase fluid over the surface of a second tray before passing the gas phase fluid over a surface of the first tray.

A twenty second aspect can include the method of any one of the seventeenth to twenty first aspects, wherein the plurality of trays or stages comprise a plurality of cascading trays arranged in a spiral configuration.

A twenty third aspect can include the method of the twenty second aspect, wherein the gas pathway passes over a surface of each tray of the plurality of cascading trays in a spiral pathway through the reactor vessel.

A twenty fourth aspect can include the method of the seventeenth or eighteenth aspect, wherein the plurality of trays or stages comprise a plurality of sieve trays, wherein each sieve tray of the plurality of sieve trays comprise one or more holes.

A twenty fifth aspect can include the method of the twenty fourth aspect, further comprising: passing the molten media from a first tray of the plurality of sieve trays to a second tray of the plurality of sieve trays through a downcomer, wherein the first tray is above the second tray, wherein the downcomer has an upper end above a surface of the first tray, and where the downcomer has a lower end disposed below a liquid level of a second tray below the first tray; and preventing the gas phase fluid from flowing through the downcomer based on the lower end being below the liquid level of the second tray.

A twenty sixth aspect can include the method of the twenty fourth or twenty fifth aspect, wherein passing the gas phase fluid through the gas pathway comprises passing the gas phase fluid through the one or more holes in each sieve tray of the plurality of sieve trays.

A twenty seventh aspect can include the method of the seventeenth or eighteenth aspect, wherein the plurality of trays or stages comprises a plurality of cascading trays, where a gas inlet is disposed along an upper surface of each tray of the plurality of cascading trays, and wherein a downcomer is disposed through each tray.

A twenty eighth aspect can include the method of the twenty seventh aspect, wherein the gas inlet comprises a nozzle, jet, sparger, manifold, or a combination thereof.

A twenty ninth aspect can include the method of the twenty seventh or twenty eighth aspect, wherein the gas pathway passes over a surface of the molten media on a first tray, through the gas inlet on a second tray, and through the molten media on the second tray, wherein the second tray is above the first tray.

A thirtieth aspect can include the method of the seventeenth or eighteenth aspect, wherein the plurality of trays or stages comprises a plurality of sieve trays, wherein each sieve tray of the plurality of sieve trays comprise one or more holes, and wherein the plurality of sieve trays are flooded with the molten media.

A thirty first aspect can include the method of the thirtieth aspect, wherein the gas pathway is disposed through the one or more holes in each sieve tray of the plurality of sieve trays.

A thirty second aspect can include the method of the thirtieth or thirty first aspect, further comprising: a packing disposed between adjacent sieve trays of the plurality of sieve trays, wherein the method further comprises: passing the gas phase fluid through the packing.

In a thirty third aspect, a molten media reactor comprises: a reactor vessel; a first direct contact heat exchanger disposed in an upper portion of the reactor vessel; a second direct contact heat exchanger disposed in a lower portion of the reactor vessel; and a reaction zone located between the first direct contact heat exchanger and the second direct contact heat exchanger.

A thirty fourth aspect can include the reactor of the thirty third aspect, further comprising: a feed gas inlet in the lower portion of the reactor vessel, and a molten media inlet in the upper portion of the reactor vessel.

A thirty fifth aspect can include the reactor of the thirty third or thirty fourth aspect, further comprising: a molten media outlet disposed in the lower portion of the reactor vessel; and a product outlet disposed in the upper portion of the reactor vessel.

A thirty sixth aspect can include the reactor of any one of the thirty third to thirty fifth aspects, wherein the first direct contact heat exchanger or the second direct contact heat exchanger comprises: a plurality of trays configured to pass a molten media downwards through the plurality of trays; and a gas pathway defined through the plurality of trays, wherein the gas pathway is configured to pass a gaseous fluid through the plurality of trays in direct contact with the molten media.

A thirty seventh aspect can include the reactor of any one of the thirty third to thirty sixth aspects, further comprising: a molten media recycle line fluidly coupled to the molten media outlet and the molten media inlet.

A thirty eighth aspect can include the reactor of the thirty seventh aspect, further comprising: a pump disposed in the molten media recycle line, wherein the pump is configured to recycle the molten media from the molten media outlet to the molten media inlet.

A thirty ninth aspect can include the reactor of the thirty seventh aspect, further comprising: a gas injection inlet in the molten media recycle line; and a gas outlet in the molten media recycle line, wherein the gas injection inlet is configured to pass a gas phase fluid through the molten media in the molten media recycle line and cause the molten media to pass from the molten media outlet to the molten media inlet, and wherein the gas outlet is configured to remove the gas phase fluid from the molten media in the molten media recycle line prior to the molten media passing through the molten media inlet.

A fortieth aspect can include the reactor of any one of the thirty third to thirty ninth aspects, further comprising: a molten media bypass line, wherein the molten media bypass line is configured to pass a molten media from the first direct contact heat exchanger to the second direct contact heat exchanger and bypass the reaction zone.

A forty first aspect can include the reactor of any one of the thirty third to fortieth aspects, wherein the first direct contact heat exchanger is configured for counter-current flow of a gas and the molten media, wherein the second direct contact heat exchanger is configured for counter-current flow of a gas and the molten media, and wherein the reaction zone is configured for co-current flow of the gas the molten media.

A forty second aspect can include the reactor of any one of the thirty third to forty first aspects, further comprising: an external heater fluidly coupled to the reaction zone, wherein the external heater is configured to receive molten media from an upper portion of the reaction zone, heat the molten media in the external heater, and pass the molten media to a lower portion of the reaction zone.

A forty third aspect can include the reactor of the forty second aspect, wherein the external heater comprises a gas inlet configured to receive a combustible gas, and a gas outlet configured to remove combustion products from the external heater.

A forty fourth aspect can include the reactor of the forty third aspect, wherein the gas inlet comprises a nozzle configured to inject the combustion products into the molten media in the external heater and create an upwards flow of the molten media within the external heater.

A forty fifth aspect can include the reactor of the forty second aspect, wherein the external heater comprises an electric heating element configured to heat the molten media in the external heater.

A forty sixth aspect can include the reactor of the forty second aspect, wherein the external heater comprises a plurality of electrodes configured to resistively heat the molten media in the external heater.

A forty seventh aspect can include the reactor of any one of the thirty third to forty first aspects, further comprising: an insert disposed in the reaction zone, wherein the insert is configured to direct the molten media through a central flow area, and wherein the insert defines an annular flow passage between the insert and a wall of the reactor vessel.

A forty eighth aspect can include the reactor of the forty seventh aspect, further comprising: a plurality of electrodes disposed at the central flow area, wherein the plurality of electrodes is configured to resistively heat the molten media within the central flow area.

In a forty ninth aspect, a method comprises: passing a molten media into an upper portion of a reactor vessel; passing a feed gas into a lower portion of the reactor vessel; pyrolyzing the feed gas in a central portion of the reactor vessel to form reaction products; heating the molten media in the upper portion of the reactor vessel using direct contact heat exchange between the molten media and the reaction products; cooling the molten media in the lower portion of the reactor vessel using direct contact heat exchange between the molten media and the feed gas; and passing the molten media out of the reactor vessel after cooling the molten media in the lower portion of the reactor vessel.

A fiftieth aspect can include the method of the forty ninth aspect, further comprising: passing the reaction products out of an upper portion of the reactor vessel.

A fifty first aspect can include the method of the forty ninth or fiftieth aspect, wherein heating the molten media in the upper portion of the reactor vessel comprises: passing the molten media through a plurality of trays; passing the reaction products over the plurality of trays; and heating the molten media and cooling the reaction products based on passing the reaction products over the plurality of trays.

A fifty second aspect can include the method of any one of the forty ninth to fifty first aspects, further comprising: recycling the molten media passing out of the lower portion of reactor vessel to the upper portion of the reactor vessel.

A fifty third aspect can include the method of the fifty second aspect, wherein recycling the molten media comprises pumping the molten media through a molten media recycle line.

A fifty fourth aspect can include the method of the fifty second aspect, wherein recycling the molten media comprises: injecting a gas into the molten media in the molten media recycle line; passing the molten media through the molten media recycle line in response to injecting the gas; and removing the gas from the molten media recycle line prior to passing the molten media into the upper portion of the reactor vessel.

A fifty fifth aspect can include the method of any one of the thirty third to fifty fourth aspects, further comprising: passing at least a portion of the molten media from the upper portion of the reactor vessel to the lower portion of the reactor vessel without passing through the central portion of the reactor vessel.

A fifty sixth aspect can include the method of any one of the thirty third to fifty fifth aspects, wherein the reaction products and the molten media have a counter-current flow in the upper portion and the lower portion of the reactor vessel, and wherein the feed gas, the reaction products, and the molten media have a co-current flow in the central portion of the reactor vessel.

A fifty seventh aspect can include the method of any one of the thirty third to fifty sixth aspects, further comprising: removing a portion of the molten media from the central portion of the reactor vessel; heating the portion of the molten media to produce a heated molten media; and passing the heated molten media back to the central portion of the reactor vessel.

A fifty eighth aspect can include the method of the fifty seventh aspect, wherein the portion of the molten media is removed from a top portion of the central portion of the reactor vessel, and wherein the heated molten media is passed back to a bottom portion of the central portion of the reactor vessel.

A fifty ninth aspect can include the method of the fifty seventh or fifty eighth aspect, wherein heating the portion of the molten media comprises: combusting a gas to produce combustion products; and contacting the combustion products with the molten media to produce the heated molten media.

A sixtieth aspect can include the method of the fifty ninth aspect, wherein heating the portion of the molten media further comprises: injecting the combustion products through a nozzle; and creating an upward flow of the molten media to pass the heated molten media back to the central portion of the reactor vessel.

A sixty first aspect can include the method of the fifty seventh or fifty eighth aspect, wherein heating the portion of the molten media comprises at least one of: electrically heating the molten media or resistively heating the molten media.

A sixty second aspect can include the method of any one of the thirty third to fifty sixth aspects, further comprising: directing the feed gas through a central flow area in the central portion of the reactor vessel; heating the molten media in the central flow area; passing the reaction products and the molten media upwards from the central flow area; and passing the molten media downwards in an annular flow channel in the central portion of the reactor vessel after passing the molten media through the central flow area.

While several embodiments have been provided in the present disclosure, it should be understood that the disclosed systems and methods may be embodied in many other specific forms without departing from the spirit or scope of the present disclosure. The embodiments and present examples are to be considered as illustrative and not restrictive, and the intention is not to be limited to the details given herein. Many variations and modifications of the systems and methods disclosed herein are possible and are within the scope of the disclosure. For example, the various elements or components may be combined or integrated in another system or certain features may be omitted or not implemented. Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

Numerous other modifications, equivalents, and alternatives, will become apparent to those skilled in the art once the above disclosure is fully appreciated. It is intended that the following claims be interpreted to embrace all such modifications, equivalents, and alternatives where applicable. Accordingly, the scope of protection is not limited by the description set out above but is only limited by the claims which follow, that scope including all equivalents of the subject matter of the claims. Each and every claim is incorporated into the specification as an embodiment of the present systems and methods. Thus, the claims are a further description and are an addition to the detailed description of the present invention. The disclosures of all patents, patent applications, and publications cited herein are hereby incorporated by reference.

1. A direct contact heat exchanger for a molten media reactor, the exchanger comprising:
a plurality of trays or stages disposed in a vessel;
a molten media flow path configured to pass a molten media through the plurality of trays or stages; and
a gas pathway disposed through the plurality of trays or stages, wherein the gas pathway is configured to directly contact a gas phase fluid with the molten media on the plurality of trays or stages.

2. The exchanger of claim 1, further comprising:
a molten media disposed within the plurality of trays or stages on the molten media flow path.

3. The exchanger of claim 1, wherein the plurality of trays or stages comprise a plurality of cascading trays.

4. The exchanger of claim 1, wherein the plurality of trays or stages comprise a plurality of sieve trays, wherein each sieve tray of the plurality of sieve trays comprise one or more holes.

5. The exchanger of claim 4, wherein the gas pathway is defined through the one or more holes in each sieve tray of the plurality of sieve trays.

6. The exchanger of claim 4, further comprising:
a packing disposed between adjacent sieve trays of the plurality of sieve trays, wherein the gas pathway is configured to pass through the packing.

7. A method of exchanging heat in a molten media reactor, the method comprising:
passing a molten media through a plurality of trays or stages in a reactor vessel;
passing a gas phase fluid through a gas pathway through the plurality of trays or stages; and
contacting the molten media with a gas phase fluid within the reactor vessel, wherein the gas phase fluid directly contacts the molten media on the plurality of trays or stages.

8. The method of claim 7, wherein the molten media comprises a molten metal, a molten salt, or any combination thereof.

9. The method of claim 7, wherein the plurality of trays or stages comprises a plurality of cascading trays, where a gas inlet is disposed along an upper surface of each tray of the plurality of cascading trays, and wherein a downcomer is disposed through each tray.

10. The method of claim 7, wherein the plurality of trays or stages comprises a plurality of sieve trays, wherein each sieve tray of the plurality of sieve trays comprise one or more holes, and wherein the plurality of sieve trays are flooded with the molten media.

11. The method of claim 10, wherein the gas pathway is disposed through the one or more holes in each sieve tray of the plurality of sieve trays.

12. The method of claim 10, further comprising:
a packing disposed between adjacent sieve trays of the plurality of sieve trays, wherein the method further comprises: passing the gas phase fluid through the packing.

13. A molten media reactor comprising:
a reactor vessel;
a first direct contact heat exchanger disposed in an upper portion of the reactor vessel;
a second direct contact heat exchanger disposed in a lower portion of the reactor vessel; and
a reaction zone located between the first direct contact heat exchanger and the second direct contact heat exchanger.

14. The reactor of claim 13, further comprising:
a feed gas inlet in the lower portion of the reactor vessel, and
a molten media inlet in the upper portion of the reactor vessel.

15. The reactor of claim 13, further comprising:
a molten media outlet disposed in the lower portion of the reactor vessel; and
a product outlet disposed in the upper portion of the reactor vessel.

16. The reactor of claim 13, wherein the first direct contact heat exchanger or the second direct contact heat exchanger comprises:
a plurality of trays configured to pass a molten media downwards through the plurality of trays; and
a gas pathway defined through the plurality of trays, wherein the gas pathway is configured to pass a gaseous fluid through the plurality of trays in direct contact with the molten media.

17. The reactor of claim 13, further comprising:
a molten media recycle line fluidly coupled to the molten media outlet and the molten media inlet.

18. The reactor of claim 17, further comprising:
a pump disposed in the molten media recycle line, wherein the pump is configured to recycle the molten media from the molten media outlet to the molten media inlet.

19. The reactor of claim 13, wherein the first direct contact heat exchanger is configured for counter-current flow of a gas and the molten media, wherein the second direct contact heat exchanger is configured for counter-current flow of a gas and the molten media, and wherein the reaction zone is configured for co-current flow of the gas the molten media.

20. The reactor of claim 13, further comprising:
an external heater fluidly coupled to the reaction zone, wherein the external heater is configured to receive molten media from an upper portion of the reaction zone, heat the molten media in the external heater, and pass the molten media to a lower portion of the reaction zone.

21. The reactor of claim 13, further comprising:
an insert disposed in the reaction zone, wherein the insert is configured to direct the molten media through a central flow area, and wherein the insert defines an annular flow passage between the insert and a wall of the reactor vessel.

22. A method comprising:
passing a molten media into an upper portion of a reactor vessel;
passing a feed gas into a lower portion of the reactor vessel;
pyrolyzing the feed gas in a central portion of the reactor vessel to form reaction products;
heating the molten media in the upper portion of the reactor vessel using direct contact heat exchange between the molten media and the reaction products;
cooling the molten media in the lower portion of the reactor vessel using direct contact heat exchange between the molten media and the feed gas; and
passing the molten media out of the reactor vessel after cooling the molten media in the lower portion of the reactor vessel.

23. The method of claim 22, wherein heating the molten media in the upper portion of the reactor vessel comprises:
passing the molten media through a plurality of trays;
passing the reaction products over the plurality of trays; and
heating the molten media and cooling the reaction products based on passing the reaction products over the plurality of trays.

24. The method of claim 22, further comprising:
recycling the molten media passing out of the lower portion of reactor vessel to the upper portion of the reactor vessel.

25. The method of claim 24, wherein recycling the molten media comprises pumping the molten media through a molten media recycle line.

26. The method of claim 22, further comprising:
removing a portion of the molten media from the central portion of the reactor vessel;
heating the portion of the molten media to produce a heated molten media; and
passing the heated molten media back to the central portion of the reactor vessel.

27. The method of claim 22, further comprising:
directing the feed gas through a central flow area in the central portion of the reactor vessel;
heating the molten media in the central flow area;
passing the reaction products and the molten media upwards from the central flow area; and
passing the molten media downwards in an annular flow channel in the central portion of the reactor vessel after passing the molten media through the central flow area.
